(19) United States
(12) Patent Application Publication
(10) Pub. No.: US 2008/0260985 A1
(43) Pub. Date: Oct. 23, 2008

(54) Information-recording medium

(75) Inventors: Hiroshi Shirai, Ibaraki-shi (JP); Kazuyoshi Adachi, Ibaraki-shi (JP); Osamu Ishizaki, Ibaraki-shi (JP); Tsuyoshi Onuma, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., IBARAKI-SHI (JP)

(21) Appl. No.: 12/068,531

(22) Filed: Feb. 7, 2008

(30) Foreign Application Priority Data
Apr. 23, 2007 (JP) 2007-112520

(51) Int. Cl. G11B 7/24

(52) U.S. Cl. 428/64.5

(57) ABSTRACT

An information-recording medium includes first and second recording layers each of which is formed of a phase-change material containing Bi, Ge, and Te, wherein the first recording layer is arranged nearer to a light-incident side of the laser beam than the second recording layer; a composition of Bi, Ge, and Te contained in the second recording layer is within a composition range surrounded by composition points B2, C2, D2, D6, C6, and B6 on a triangular composition diagram of Bi, Ge, and Te; and a difference (α−δ) between a composition α of Bi in the first recording layer and a composition δ of Bi in the second recording layer is −1.0 to 3.0 at. %. Thus, there is provided a two-layered information-recording medium with high recording-data reliability and excellent repeated-data recording durability.

### BACKGROUND OF THE INVENTION

1. Field of the Invention

The present invention relates to an information-recording medium on which information is recorded by being irradiated with an energy beam. In particular, the present invention relates to a phase-change optical disk which is adapted to the blue laser and which has two layers of phase-change recording layers.

2. Description of the Related Art

In recent years, the market is expanded in relation to the read-only optical disk including, for example, DVD-ROM and DVD-Video. Following the above, the market is being quickly expanded in relation to the rewritable DVD (hereinafter referred to as “recordable DVD” as well) including, for example, DVD-RAM, DVD-RW, and DVD+RW as a backup medium for a computer and an image recording medium to replace VTR. As the market is expanded, in recent years, it is increasingly demanded for the recordable DVD to realize the large capacity and improve the transfer rate and the access speed.

In the case of the recordable DVD such as DVD-RAM and DVD-RW on which the recording is erasable, the phase-change recording system is adopted, in which a phase-change material is used for a recording layer in which the information is recorded. In the case of the phase-change recording system, the recording is basically performed such that the information of “0” and the information of “1” are allowed to correspond to the crystalline state and the amorphous state of the phase-change material respectively. The refractive index differs between the crystalline state and the amorphous state of the phase-change material. Therefore, for example, the refractive indexes and the thicknesses of the respective layers constructing the recordable DVD are designed so that the difference in the reflectance is maximized between a portion which is changed to the crystal and a portion which is changed to the amorphous. The laser beam is radiated onto the crystallized portion and the amorphous portion to detect the difference in the amount of the reflected light coming from the respective portions of the optical disk so that the information “0” and the information “1”, which are recorded in the recording layer, are detected.

In order to make a predetermined position to be amorphous (this operation is usually referred to as “recording”), a laser beam having a relatively high power is radiated to effect heating so that the temperature of the recording layer is not less than the melting point of the recording layer material. On the other hand, in order to make a predetermined position to be crystalline (this operation is usually referred to as “erasing”), a laser beam having a relatively low power is radiated to effect heating so that the temperature of the recording layer is in the vicinity of the crystallization temperature which is not more than the melting point of the recording layer material. In this way, the state of the predetermined portion can be reversibly changed between the amorphous state and the crystalline state by adjusting the power of the laser beam to be radiated onto the predetermined portion of the recording layer.

A method, in which the number of revolutions of the medium is increased to perform the recording and the erasing in a short period of time, is generally adopted as the method for improving the transfer rate on the recordable DVD as described above. However, in the case of such a method, a problem arises in relation to the recording/erasing characteristic when the information is overwritten on the medium. This problem will be explained in detail below.

A consideration is made about a case in which the predetermined position of the medium is changed from the amorphous to the crystalline. When the number of revolutions of the medium is increased, then a period of time, in which the laser beam passes across the predetermined position of the medium, is shortened; and at the same time, a period of time, in which the predetermined position is maintained at the crystallization temperature, is shortened as well. If the period of time, in which the predetermined position is maintained at the crystallization temperature, is too short, the crystal growth cannot be effected sufficiently. Therefore, the amorphous remains. The remaining amorphous is reflected to the reproduced signal, and the quality of the reproduced signal is deteriorated.

A method, in which Sn is added to a Ge—Sb—Te-based phase-change recording material which is generally used for the recording layer of the recordable DVD, is hitherto known as a method for solving the foregoing problem. Other than the above, for example, Japanese Patent Application Laid-open No. 2001-322357 discloses an information-recording medium which is obtained by using a material prepared by adding a metal such as Ag, Al, Cr, and/or Mn to a Ge—Sn—Sb—Te-based material as a material for the recording layer, in which the high density recording can be performed on the information-recording medium, the information-recording medium is excellent in the repeated rewriting performance, and the crystallization sensitivity scarcely undergoes the time-dependent deterioration.

A practical composition range has been hitherto suggested as well, in which a Bi—Ge—Te-based phase-change material is used as a recording layer material (see, for example, Japanese Patent Application Laid-open No. 62-209741). Further, a practical composition range has been hitherto suggested as well for a Bi—Ge-TE-based phase-change material which is adaptable to the 2× speed and the 5× speed of DVD-RAM (see, for example, Japanese Patent Application Laid-open No. 2004-155177).

On the other hand, Bi—Ge—Se—Te-based phase-change recording materials are disclosed in Japanese Patent Application Laid-open Nos. 62-73439 and 1-220236. Further, a practical range of a Bi—Ge—Sb—Te-based phase-change recording material is defined in Japanese Patent Application Laid-open No. 1-287836.

In PCOS 2001, a Ge—Sn—Sb—Te-based material is reported as a recording material adaptable to a range from the 2× speed to the 4× speed of DVD-RAM. In ISOM/ODS 2002, an information-recording medium is reported, which is adaptable to the 2× speed and the 5× speed of DVD-RAM. This 5× speed medium can be adapted to the 5× speed by providing an eight-layered structure by newly adding a nucleation layer.

A method is well-known as a technique for providing a large capacity for the recordable DVD, in which the wavelength of the laser beam is shortened to 405 nm, and the objective lens NA is increased to 0.85 so that the laser spot diameter is decreased to record the information at a higher density (Jpn. J. Appl. Phys. Vol. 39 (2000), pp. 756-761, Part 1, No. 2B, February 2000). This method is utilized as a main technique commonly known by the name of Blu-ray Disc in which the influence exerted on the tilt of the disk is decreased by adopting a substrate having a thickness of 0.1 mm which is thinner than those for conventional DVD. The substrate having the thickness of 0.1 mm plays important roles including, for example, the mechanical protection and the electrochemical production (prevention of corrosion; anti-corrosion) of the recording layer.

The basic structure of a conventional rewritable optical disk such as DVD-RAM and DVD-RW is a four-layered structure in which a first dielectric layer, a phase-change recording layer, a second dielectric layer, and a reflective layer are successively stacked on a substrate made of polycarbonate (PC) having a thickness of 0.6 mm. The optical disk is manufactured by further sticking a substrate having a thickness of 0.6 mm from the side of the reflective layer. However, in the case of Blu-ray Disc described above, if the disk is manufactured by using the same stacking structure as that of the conventional optical disk, it is difficult to maintain the rigidity of the substrate, because the thickness of the substrate is thin, i.e., 0.1 mm. Therefore, Blu-ray Disc is manufactured as follows. That is, a reflective layer, a second dielectric layer, a phase-change recording layer, and a first dielectric layer are successively stacked (stacked in an order opposite to that of the conventional rewritable optical disk) on a thick substrate, for example, on a PC substrate having a thickness of 1.1 mm; and finally a substrate having a thickness of 0.1 mm is formed as a cover layer (protective layer) from the side of the first dielectric layer. Those suggested as the method for forming the cover layer of Blu-ray Disc include a method in which a sheet having a thickness of 0.1 mm is stuck with an ultraviolet-curable resin adhesive on the first dielectric layer, and a method in which an ultraviolet-curable resin is uniformly coated on the surface of the first dielectric layer by the spin coat method, and the ultraviolet-curable resin is cured by being irradiated with a ultraviolet light to form the cover layer.

An Ag—In—Sb—Te-based recording material, which is disclosed, for example, in Japanese Patent No. 2941848, can be used as the recording material for Blu-ray Disc. Japanese patent No. 2941848 also discloses in detail the composition of the recording material obtained by adding a fifth element and a sixth element to the Ag—In—Sb—Te-based recording material.

A method is also suggested as another method for realizing a large capacity of the recordable DVD, in which respective layers are stacked in the same order as that of the conventional technique on a substrate having a thickness of 0.6 mm to manufacture an optical disk, and the information is recorded on the optical disk while the wavelength of the laser beam is 405 nm and the objective lens NA is 0.65. This method is used for a disk commonly known by the name of HD DVD (High Density DVD). In HD DVD, the laser spot diameter is large, and the recording density is low, because the objective lens NA is small as compared with the method in which the cover layer having the thickness of 0.1 mm is used as in Blu-ray Disc described above. However, the HD DVD has an advantage such that the rigidity of the substrate can be easily maintained, and the recording layer is easily allowed to have multiple layers. as well as an advantage such that the influence of dust and scratch on the medium can be decreased.

The so-called wobble track, in which the recording track is meandered, is adopted for the technique of, for example, DVD-RAM, DVD-RW, DVD+RW, Blu-ray Disc, and HD DVD described above. Address information and synchronization signal etc. are recorded on the wobble; and the format is utilized highly efficiently by reproducing the recording signal with the sum signal and by reproducing the wobble signal with the difference signal. This technique is known as a means which is extremely effective to improve, for example, the reliability of the address information and the recorded information, because the synchronization signal can be taken from the wobble signal as well.

Further, HD DVD described above adopts the PRML (Partial Response and Maximum Likelihood) signal processing system in order that the information, which is recorded at a higher density as compared with DVD, is correctly recorded and reproduced. The techniques are disclosed, for example, in Japanese Patent No. 3565356 and Japanese Patent Application Laid-open Nos. 2001-319430, 2002-32961, and 2003-151220. The PRML signal processing system will now be explained.

At first, for example, a case is considered, in which a recorded information, which has a density higher than that of the current DVD, is reproduced by using an optical head same as that used in the current DVD. When the track density is increased, a reproduced signal in a certain track contains a large amount of the leakage component (crosstalk component) originating from a signal recorded on an adjacent track adjacent to the certain track. On the other hand, when the linear density is increased, then the waveform interference tends to be caused between the respective data (between the recording marks), and the reproduced waveform has a more distorted shape. In such a situation, an equalizer is usually used for the reproduced signal so that the high frequency component is amplified to correct the distortion of the reproduced waveform, and the waveform equalization is performed. However, when the reproduced waveform to be inputted is more distorted, the high frequency component needs to be amplified more intensively than in the current DVD. As a result, the equalizer also amplifies the deteriorated component of the reproduced signal as described above. The current DVD uses the waveform slice system as the signal detection system. However, if the deteriorated component of the reproduced signal is increased as described above, it is difficult to decode the data in the case of this system. The PRML signal processing system has been proposed as a system to solve such a problem.

The principle of the PRML signal processing system will be explained in detail with reference to FIGS. 17 and 18. The PRML signal processing system is a processing system which combines the equalization technique for correcting the reproduced signal into the PR characteristic and the ML decoding technique for discriminating the signal by utilizing the inter-symbol interference. In general, the PR characteristic for a 1-bit recording signal is expressed by arranging the impulse response sequence, which is expressed, for example, as PR(a0, a1, a2, a3, a4). This shows that a reproduced signal, which is provided for the 1-bit recording signal, is expressed as a sequence which has signal levels (voltage levels) of a0, a1, a2, a3, and a4. An example is shown in FIG. 17. FIG. 17 shows a case that the PR characteristic, which corresponds to a 1-bit isolated waveform, is PR (1, 2, 2, 2, 1). This is the PR characteristic which is close to the reproduced signal characteristic of HD DVD.

FIG. 17A shows a 1-bit isolated waveform (1-bit recording signal) having a channel bit length T (channel clock). FIG. 17B shows an impulse response for the isolated waveform. In this case, in response to the 1-bit recording signal, the reproduced signal appears as the waveform of the sequence in which the signal voltage levels (voltage levels at the sample points) are [1, 2, 2, 2, 1] at intervals of the channel clock period T as shown in FIG. 17B. The recording signal (modulated code) to be recorded includes signals having different lengths (signals of integral multiples of the channel clock period T). Therefore, as shown in FIG. 18, the reproduced signal sequence, which corresponds to the recording signal, is expressed by the addition of the impulse responses with respect to the recording bits respectively (principle of superimposition). The added reproduced signal sequence of the impulse responses (waveform indicated by a broken line in FIG. 18) is referred to as “path”. When PR (1, 2, 2, 2, 1) is adopted for the PR characteristic, the reproduced signal sequence after the equalization is converted into a signal sequence having nine signal levels as shown in FIG. 18.

In the equalizer in the PRML signal processing system, the processing is performed so that the reproduced signal of the optical disk is adjusted to match the PR characteristic to be used. In this procedure, by selecting the PR characteristic, which is similar to the reproduced signal characteristic of the optical disk, the increase in the noise component is suppressed, which would be otherwise caused by the equalization.

On the other hand, when the reproduced signal sequence is discriminated by using the ML decoding technique, the reproduced signal is discriminated by comparing an actually obtained reproduced signal waveform with all of the assumed paths. However, the actual reproduced signal sequence includes a noise, etc. Therefore, the actual reproduced signal sequence is not completely coincident with any of the paths. Accordingly, in the ML decoding technique, the following procedure is usually adopted. That is, errors are calculated at respective sample point between the detected reproduced signal waveform and all of the assumed paths, and a path, in which the cumulative value of the errors is smallest among the paths, is selected. The bit sequence, which corresponds to the selected path one-to-one, is outputted as the reproduced information.

As described above, the ML decoding technique is not a system (waveform slice system) in which the signal is discriminated based on the level at a certain sample point of the detected reproduced signal waveform but is a system in which a known correlation (inter-symbol interference) of the reproduced signal possessed by the PR characteristic is positively utilized to perform the discrimination. Therefore, the ML decoding technique has such a feature that the technique is strong against the noise. However, as described above, it is necessary to calculate the errors between the detected reproduced signal waveform and all of the assumed paths. Therefore, the amount of calculation is enormous. Therefore, in the case of the ML decoding technique, the Viterbi decoder is used in order to efficiently execute the discrimination of the reproduced signal sequence.

On the other hand, an information-recording medium has been hitherto suggested, in which two recording layers are provided to brought about the two-fold recording capacity in order to increase the recording capacity for recording the information (hereinafter referred to as “two-layered recording medium” as well; and see, for example, Japanese Patent Application Laid-open Nos. 2000-36130 and 2002-144736). In the case of the two-layered information-recording medium, the laser beam is allowed to come from one side of the medium, and the information is recorded and reproduced in the two recording layers.

As described above, the two-layered information-recording medium is usually constructed of a first information-recording section including a recording layer (hereinafter referred to as “first recording layer” as well) which is arranged or located close to the light-incident side or the light-incoming side of the laser beam and a metal reflective film which reflects the laser beam when the information is recorded and reproduced in the first recording layer; and a second information-recording section including a recording layer (hereinafter referred to as “second recording layer” as well) which is arranged on another side far from the light-incident side of the laser beam. In such a two-layered information-recording medium, the laser beam is radiated from one side of the medium as described above to record and reproduce the information in the two recording layers. Therefore, the information is recorded and reproduced in the second information-recording section by the laser beam transmitted through the first information-recording section. Therefore, it is necessary that the thicknesses of the first recording layer and the metal reflective layer of the first information-recording section are made extremely thin to enhance the transmittance. Upon reproducing the information recorded in the second information-recording section, it is also necessary to enhance the reflectance of the second information-recording section itself, because the reflected light beam from the second information-recording section is detected after being transmitted through the first information-recording section.

As described above, it is essential to use the blue laser (wavelength: 400 to 410 nm) to realize the large capacity of the information-recording medium, and various recording layer materials have been suggested for this purpose. In order to correctly record and reproduce the recording information allowed to have the high density, the PRML signal processing system is introduced into the next generation optical disk, i.e., HD DVD as described above, without using the conventional detection system (waveform slice system). Further, the two-layered information-recording medium, which has the two recording layers, has been also suggested to realize the large capacity. Accordingly, a recording layer is demanded, which is suitable for the two-layered information-recording medium using the PRML signal processing system.

### SUMMARY OF THE INVENTION

An object of the present invention is to provide a two-layered information-recording medium which has two recording layers, which is adapted to the PRML signal processing technique by specifically optimizing the structure of the two-layered information-recording medium adapted to the blue laser using a Bi—Ge—Te-based phase-change material for each of the recording layers, which provides the high reliability of the recording data, and which is excellent in the repeated-date recording durability.

According to a first aspect of the present invention, there is provided an information-recording medium capable of rewriting information a plurality of times by being irradiated with a laser beam under a condition of 46.5 nsec≦(λ/NA)/V≦116.0 nsec and λ=400 to 410 nm provided that a wavelength of the laser beam is represented by λ nm, a numerical aperture of an objective lens for collecting the laser beam is represented by NA, and a recording linear velocity is represented by V m/sec, the information-recording medium comprising: a first recording layer which is formed of a phase-change material containing Bi, Ge, and Te; and a second recording layer which is formed of a phase-change material containing Bi, Ge, and Te; wherein the first recording layer is arranged nearer to a light-incident side of the laser beam than the second recording layer; a composition of Bi, Ge, and Te contained in the second recording layer is within a composition range surrounded by the following respective points on a triangular composition diagram of Bi, Ge, and Te:
B2 (Bi_{2.0}, Ge_{47.5}, Te_{50.5});
C2 (Bi_{2.5}, Ge_{48.5}, Te_{49.0});
D2 (Bi_{3.0}, Ge_{50.0}, Te_{47.0});
D6 (Bi_{10.0}, Ge_{50.0}, Te_{40.0});
C6 (Bi_{9.0}, Ge_{44.5}, Te_{46.5});
B6 (Bi_{8.0}, Ge_{40.5}, Te_{51.5}); and

a difference (α−δ) between a composition ax of Bi contained in the first recording layer and a composition δ of Bi contained in the second recording layer is −1.0 to 3.0 at. %.

In the information-recording medium of the present invention, it is preferable that a composition of Bi, Ge, and Te contained in the first recording layer is within a composition range surrounded by the following respective points on the triangular composition diagram of Bi, Ge, and Te:
B1 (Bi_{1.0}, Ge_{49.0}, Te_{50.0});
C1 (Bi_{1.5}, Ge_{49.0}, Te_{49.5});
D1 (Bi_{2.0}, Ge_{50.0}, Te_{48.0});
D8 (Bi_{13.0}, Ge_{50.0}, Te_{37.0});
C8 (Bi_{12.0}, Ge_{43.0}, Te_{45.0});
B8 (Bi_{11.0}, Ge_{36.5}, Te_{52.5}).

The composition range [B1, C1, D1, D8, C8, B8] described above is a composition range which is determined from the composition range [B2, C2, D2, D6, C6, B6] and the relationship of the difference (α−δ)=−1.0 to 3.0 at. % between the composition α of Bi contained in the first recording layer and the composition δ of Bi contained in the second recording layer. The composition points B1 and B8 described above represent the compositions of the B series (on the broken line B shown in FIG. 8) as described later on, in the same manner as the composition points B2 and B6. The composition points C1 and C8 described above represent the compositions of the C series (on the broken line C shown in FIG. 8) as described later on, in the same manner as the composition points C2 and C6. The composition points D1 and D8 described above represent the compositions of the D series (on the broken line D shown in FIG. 8) as described later on, in the same manner as the composition points D2 and D6.

The inventors of the present invention performed the recording and reproduction under the standard condition of HD DVD (laser wavelength: 405 nm, numerical aperture NA of the objective lens: 0.65, recording linear velocity: 5.6 m/sec) by using the Ge—Sb—Te-based material, the Ge—Sn—Sb—Te-based material, the Bi—Ge—Sb—Te-based material, and the Ag—In—Sb—Te-based material explained in the conventional technique section as the materials for forming the recording layers respectively of the two-layered information-recording medium. As a result, the inventors have found out that the following problems arise.

### First Problem

Even by using the PRML signal processing system, in which the PR (1, 2, 2, 2, 1) characteristic was adopted, it was impossible to correctly record and reproduce the information. The inventors diligently investigated this problem and obtained the following knowledge as a result.

As described above, in the PR (1, 2, 2, 2, 1) characteristic, as shown in FIG. 18, the reproduced signal sequence is distributed as much as at nine levels. Therefore, when the characteristic of the actually detected reproduced signal is deteriorated, then the equalization cannot be performed correctly, and any discrimination error or any identification error arises. When a random pattern information, which includes a signal having a length of nT (T represents the channel clock period, and n is any one of 2, 3, 4, 5, 6, 7, 8, 9, 10, and 11), is recorded on the information-recording medium, then the condition, which is required for the actually detected reproduced signal to correctly perform the equalization process for the PR characteristic (hereinafter referred to as “PR equalization” as well), is the following two points.

(1) A recording mark having the shortest mark length 2 T is recorded and reproduced at the correct length.

(2) The linearity is maintained among the amplitudes of the reproduced signals having the mark lengths respectively.

In relation to the condition (1), in general, the signal, which is included most abundantly in the signal of the information of the random pattern, is the signal having the shortest mark length 2 T. Therefore, if the signal level of the length 2 T is unstable (if the lengths of the 2 T mark are not constant, then the correct PR equalization cannot be performed, the discrimination error occurs, and the error rate is consequently increased.

In relation to the condition (2), if the linearity is not maintained for the amplitudes of the reproduced signals of the respective mark lengths, then the amplitudes each having the predetermined magnitude corresponding to one of the respective mark lengths are not obtained, and the discrimination error is consequently increased. For example, when the linearity is maintained for the amplitudes of the reproduced signals having the mark lengths is maintained, then a relationship is obtained such that the amplitude of the 4 T signal is 1.33, the amplitude of the 5 T signal is 1.66, and the amplitude of the 6 T signal is 2, assuming that the amplitude of the 3 T signal is 1. However, if the linearity is not maintained, then the reproduced signals having the amplitudes of the linear relationship as described above are not obtained, and the discrimination error is increased.

When the recording and reproduction are performed under the standard condition of HD DVD (laser wavelength: 405 nm, numerical aperture of the objective lens: 0.65, recording linear velocity: 5.6 m/sec), it has been found out that the condition (1) described above can be satisfied, i.e., the signal having the shortest mark 2 T can be recorded at the correct length, by adjusting the recording strategy and the recording power. However, it has been found out that the condition (2) is difficult to hold, i.e., it is difficult to maintain the linearity among the amplitudes of the reproduced signals of the mark lengths respectively.

According to the analysis of experimental data performed by the inventors, it is estimated that the cause of the above-described situation results from the recrystallization of the recording mark. The recrystallization is the following phenomenon (shrink). That is, during a cooling process occurring immediately after heating the recording layer material to a temperature of not less than the melting point (to effect the conversion into the amorphous) by radiating the laser beam onto a predetermined position of the recording layer, the crystallization occurs from the outer edge of the melted area, and the size of the recording mark is decreased. When the shrink of the recording mark arises, the reproduced signal amplitude is lowered, because the size of the recording mark is decreased.

Usually, when the laser beam is radiated onto the information-recording medium to record a signal having the length of nT (T represents the channel clock, and n is 2, 3, 4, 5, 6, 7, 8, 9, 10, 11), then the recording is performed for the 2 T signal by radiating one pulse; and the recording is performed for signals of 3 T or more by radiating a plurality of pulses (in the case of HD DVD, the recording is performed with a (n−1) type recording pulse or pulses such that 2 T uses one pulse, 3 T uses two pulses, 4 T uses three pulses and so on). In this recording method, for example, the following process is adopted. That is, immediately after one pulse is radiated to record the 2 T signal, a cooling pulse is radiated (a pulse having a power lower than the recording power is radiated; for example, the recording power is 6 mW, and the power, which is used upon the radiation of the cooling pulse, is 0.1 mW). Thus, when the short mark 2 T is recorded, it is enough that the pulse radiation time is short. Therefore, the cooling speed of the pulse-irradiated portion of the recording layer exceeds the crystallization speed of the recording layer, wherein the recrystallization is scarcely caused, and the recording mark having the mark length 2 T can be formed over the entire track width. However, upon recording the long mark, for example, a recording mark having the mark length 11 T, the first top pulse is radiated, the cooling pulse is thereafter radiated for a short period of time, and then the next multi-pulses are successively radiated before the top pulse-irradiated portion is not cooled sufficiently. For this reason, the cooling speed of the portion irradiated with the first top pulse is slower than that when the recording is performed by the one pulse radiation to record the 2 T mark. As a result, upon recording the long mark, an area (for example, the outer edge of the melted area), in which the cooling speed of the pulse-irradiated portion of the recording layer is slower than the crystallization speed of the recording layer, is present; and the recrystallization occurs in the area. Therefore, upon recording the long mark, a part of the recording mark cannot be recorded over the entire track width, which consequently narrows the mark width. Further, it has been found out that as the mark length is longer, the mark width becomes narrower.

As described above, when the phenomenon in which the width of the recording mark differs depending on the recording mark length arises, then even if the recording is performed while maintaining the linearity for the recording mark length, the width of the recording mark becomes narrower as the mark length is longer. Therefore, as for the amplitude of the reproduced signal, any desired signal amplitude is not obtained as the mark length is longer. As a result, the linearity is deteriorated in relation to the amplitude of the reproduced signal for each of the mark lengths.

Further, when the shrink of the recording mark arises, the crystal grain size differs in relation to the crystal size between recrystallized portion and normally crystallized portion. Therefore, the reflectance dispersion occurs due to this difference, and the noise is generated. Therefore, if the shrink of the recording mark, which is caused by the recrystallization, is too large, the reproduced signal is deteriorated due to the cause as described above. The problem, which is caused by the shrink of the recording mark as described above, can be solved by lowering the crystallization velocity of the recording layer material.

### Second Problem

When a laser beam having a higher power is radiated onto the recording layer, in which the recrystallization is caused to a great extent, in order that the recording mark having a wide width is recorded on a certain track to increase the reproduced signal amplitude, then the recording mark, which has been recorded on an adjacent track adjacent to the certain track, is erased (cross-erase), and the signal quality is drastically deteriorated on the adjacent track.

Further, when the first problem (shrink of the recording mark) and the second problem (cross-erase) are caused, it is impossible to narrow the track pitch in order to realize the high density. Therefore, it is impossible to sufficiently make the most use of the effect to be brought about by decreasing the beam diameter by using the blue laser.

### Third Problem

When the laser beam having a higher power is radiated in order that the recording mark having a wide width is recorded to increase the reproduced signal amplitude, then a damage, which is exerted on the recording layer by the multiple times of rewriting, is increased, and the number of times of rewriting is decreased.

### Fourth Problem

In the case of the two-layered information-recording medium provided with two recording layers, it has been found out that the following problem further arises. According to the verifying experiment performed by the inventors, it has been found out that even when the two recording layers are composed of identical elements but if the compositions of the two recording layers differ too greatly, then the satisfactory recording and reproduction characteristic is obtained in only one of the two recording layers. This problem is considered to arise probably as follows. That is, as described later on, in a case that the satisfactory recording and reproduction characteristic is obtained in one of the recording layers, when the composition of the other of the recording layers is excessively different from the composition of the one recording layer, then the crystallization speed is drastically changed in the other recording layer, and any satisfactory crystallization speed is not obtained, in relation to the change in the crystallization speed with respect to the thickness of the recording layer in each of the information sections and the effect of the heat release of the metal reflective film (effect to cool the recording layer by quickly releasing the heat generated in the recording layer during the recording of information). Consequently, any satisfactory recording and reproduction characteristic is not obtained in the other recording layer.

The present invention has been made in order to solve the problems as described above; and an object of the present invention is to provide a two-layered information-recording medium which makes it possible to solve all of the first to fourth problems even when a signal having a length of nT (T represents the channel clock, and n is 2, 3, 4, 5, 6, 7, 8, 9, 10, 11) is recorded especially on the two-layered information-recording medium and the information is reproduced under the reproduction or playback condition of HD DVD by using the PRML signal processing technique.

The inventors have found out, through the verifying experiment, that all of the first to fourth problems can be solved, for example, even when the recording and reproduction are performed under the condition ranging from the 1× speed to the 2× speed of HD DVD, in a two-layered information-recording medium provided with two recording layers each of which is formed of a Bi—Ge—Te-based phase-change material, wherein a composition of Bi, Ge, and Te contained in the second recording layer which is arranged far from a light-incident side of a laser beam is within a composition range surrounded by the following respective composition points on a triangular composition diagram of Bi, Ge, and Te, and a difference (α−δ) between a composition a of Bi contained in the first recording layer and α composition δ of Bi contained in the second recording layer is −1.0 to 3.0 at. %:
B2 (Bi_{2.0}, Ge_{47.5}, Te_{50.5});
C2 (Bi_{2.5}, Ge_{48.5}, Te_{49.0});
D2 (Bi_{3.0}, Ge_{50.0}, Te_{47.0});
D6 (Bi_{10.0}, Ge_{50.0}, Te_{40.0});
C6 (Bi_{9.0}, Ge_{44.5}, Te_{46.5});
B6 (Bi_{8.0}, Ge_{40.5}, Te_{51.5}).

More specifically, the inventors have found out the following by the verifying experiment. That is, it is assumed that a wavelength of the laser beam is represented by λ (nm), a numerical aperture of an objective lens collecting the laser beam is represented by NA, and a recording linear velocity is represented by V (m/sec). On this assumption, a recording and reproducing condition is provided, in which a parameter (λ/NA)/V, which represents a period of time during which the laser beam spot passes across a certain point on the information-recording medium, is within a range of 46.5 to 116.0 nsec (provided that λ=400 to 410 nm is given). Under this recording and reproduction condition, the composition of Bi, Ge, and Te contained in the second recording layer is within the composition range surrounded by the foregoing composition points B2, C2, D2, D6, C6, and B6, and the difference (α−δ)=−1.0 to 3.0 at. % is provided between the composition α of Bi contained in the first recording layer and the composition δ of Bi contained in the second recording layer. Accordingly, it is possible to provide the two-layered information-recording medium capable of solving all of the first to fourth problems described, and having high reliability of the recording data and excellent repeated-data recording durability.

All of the first to fourth problems described above have been successfully solved owing to the fact that the composition of Bi, Ge, and Te contained in the second recording layer is within the foregoing composition range [B2, C2, D2, D6, C6, B6] on the triangular composition diagram of Bi, Ge, and Te, and the difference (α−δ) between the composition α of Bi contained in the first recording layer and the composition δ of Bi contained in the second recording layer has the value within the foregoing range. The reason thereof is considered as follows.

At first, an explanation will be made about the principle of suppression of the recrystallization in the recording layer (First Problem). The following hypothesis is described as the principle of suppression of the recrystallization in Japanese Patent Application Laid-open No. 2004-155177. Note that it is considered that the recrystallization is also suppressed in accordance with the same or equivalent principal in the information-recording medium of the present invention.

Compounds of GeTe, Bi₂Te₃, Bi₂Ge₃Te₆, Bi₂GeTe₄, and Bi₄GeTe₇ are present in the Bi—Ge—Te-based phase-change material within a range having been clarified up to now. After the laser beam is radiated to effect the melting in order to record the information in a predetermined portion of the recording layer (make the conversion into the amorphous), when the recrystallization occurs in a part of the melted area immediately, it is considered that the recrystallization occurs from the outer edge portion of the melted area in an order starting from a compound, among the above-mentioned compounds, which has the highest melting point among those of the above-mentioned compounds, Bi, Ge, and Te, although the situation differs depending on the composition of the recording layer. These substances are arranged as follows in an order starting from one having the highest melting point.
Ge: about 937° C.;
GeTe: about 725° C.;
Bi₂Ge₃Te₆: about 650° C.;
Bi₂Te₃: about 590° C.;
Bi₂GeTe₄: about 584° C.;
Bi₄GeTe₇: about 564° C.;
Te: about 450° C.;
Bi: about 271° C.

As described above, Ge has the highest melting point. Therefore, it is considered that Ge is more easily segregated at the outer edge portion of the melted area in the information-recording medium of the present invention wherein the phase-change material, in which Ge is added in excess, is used as the recording layer, than any material having a composition on a line connecting GeTe and Bi₂Te₃ on the triangular composition diagram having the apexes of Bi, Ge, and Te. When Ge exists in an excessive amount at the outer edge portion of the melted area, then the crystallization speed at the outer edge portion of the melted area is slow, and it is possible to suppress the recrystallization from the outer edge portion. Therefore, it is possible to suppress the appearance of the “band” of the recrystallization which would be otherwise caused by the multiple times of rewriting.

When the recrystallization from the outer edge portion of the melted area can be suppressed as described above, it is unnecessary to enhance the laser power to improve the reproduced signal amplitude so that the melting is caused over a wide area. The problem (Second Problem: cross-erase), in which the recording mark having been recorded on the adjacent track is erased, can be dissolved as well.

Further, when the recrystallization from the outer edge portion of the melted area can be suppressed as described above, the recording power, which is radiated per one time of recording, can be lowered. Therefore, it is possible to suppress the damage on the recording layer exerted by the multiple times of rewriting (Third Problem). That is, it is possible to improve the rewriting durability. Thus, the two-layered information-recording medium of the present invention can solve all of the first to third problems.

Further, the inventors have found out that through the verifying experiment. That is, in the two-layered information-recording medium, by making the composition of Bi, Ge, and Te contained in the second recording layer to be within the composition range surrounded by the composition points B2, C2, D2, D6, C6, and B6 described above; and by providing the difference (α−δ)=−1.0 to 3.0 at. % between the composition α of Bi contained in the first recording layer and the composition δ of Bi contained in the second recording layer (by making the composition of the first recording layer to be approximately same as the composition of the second recording layer), it is possible to suppress the decrease in the crystallization speed of the first and second recording layers as explained in relation to the fourth problem, and the information can be sufficiently rewritten in both of the recording layers. This is considered to be caused as follows.

In the two-layered information-recording medium provided with the two recording layers to double the recording capacity of the information, when the information is recorded and reproduced in the recording layer (second recording layer) which is arranged far from the light-incident side of the laser beam, the recording and reproduction are performed by using the laser beam which is transmitted through the first recording layer of the first information-recording section arranged near to the light-incident side of the laser beam. Therefore, in the two-layered information-recording medium, it is necessary that the thickness of the first recording layer and the metal reflective film (Ag—Ca—Cu film as described later on) of the first information-recording section is made extremely thin. When the recording layer is thin, then the crystal nuclei to be formed are decreased and the distance over which the atoms are movable is shortened, when the recording layer is subjected to the crystallization. For this reason, when the recording layer is thin, then the crystalline phase is hardly formed, and the crystallization speed is lowered. Therefore, in the two-layered information-recording medium, since the thickness of the first recording layer is thin, the crystallization speed of the first recording layer is lowered and the recrystallization is hardly caused. Further, in the two-layered information-recording medium, the thickness of the metal reflective film is thin as well. Therefore, the effect, in which the heat generated in the first recording layer during the information recording is quickly released to cool the recording layer (hereinafter referred to as “heat release effect” as well), is decreased. Therefore, in the two-layered information-recording medium, the crystallization speed of the first recording layer is lowered, but the heat release effect, which is to be provided by the metal reflective film of the first information section, is decreased. Therefore, it is possible to sufficiently secure the crystallization holding time for the first recording layer during the information recording (during the light beam radiation); and it is possible to sufficiently crystallize the amorphous portion, thereby making it possible to obtain satisfactory recording and reproduction characteristic.

When the composition of the second recording layer of the second information section is made to be same as the composition of the first recording layer in the two-layered information-recording medium, the thickness of the second recording layer is greater than that of the first recording layer. Therefore, the crystallization speed is increased as compared with the first recording layer, and the recrystallization is easily caused. However, the thickness of the metal reflective film (Ag—Ca—Cu film as described later on) of the second information section is thickened as well, and hence the heat release effect is also increased. Therefore, owing to the heat release effect of the metal reflective film of the second information section, it is possible to suppress the recrystallization of the second recording layer to the minimum; and the satisfactory recording and reproduction characteristic can be obtained from the second recording layer as well.

Therefore, in the two-layered information-recording medium, as described above, the compositions of the elements for constructing the two recording layers are made approximately identical with each other, due to the heat release effect of the metal reflective film and the change in the crystallization speed with respect to the thickness of the recording layer in each of the information sections. Accordingly, the satisfactory recording and reproduction characteristic is obtained in the two recording layers. On the contrary, when the compositions of the elements for constructing the two recording layers are excessively or too different from each other, then due to the heat release effect of the metal reflective film and the change in the crystallization speed with respect to the thickness of the recording layer in each of the information sections as described above, even when the satisfactory recording and reproduction characteristic is obtained in one of the recording layers, the crystallization is drastically changed and the satisfactory crystallization speed is not obtained in the other of the recording layers, and thus the satisfactory recording and reproduction characteristic is not obtained.

According to the analysis of the experimental data performed by the inventors, it is considered that the rewriting of information is sufficiently performed in the both recording layers, because the Bi compounds such as Bi₂Te₃ are produced as crystal nuclei in larger amounts by increasing the Bi amount in the recording layer and the crystallization speed is quickened. Further, the inventors have found out that even when the Bi amount is increased, if the Ge amount is simultaneously increased, then the effect obtained by the increase in the Bi amount (increase in the crystallization speed) and the effect obtained by the increase in the Ge amount (decrease in the crystallization speed) cancel each other out and the crystallization speed is not quickened. The inventors also have found out a preferable or suitable range of the Ge amount by which the effect to increase the crystallization speed is more evidently exhibit when the Bi amount is increased.

The foregoing explanation has been made as exemplified by the two-layered information-recording medium by way of example. However, the present invention is not limited to the two-layered information-recording medium. The present invention is also applicable to any multi-layered information-recording medium having three or more recording layers; and the same or equivalent effect is obtained provided that the condition is satisfied in relation to the composition range as described above between two recording layers among the three or more recording layers.

When the information is reproduced by using the PRML signal processing system on the information-recording medium of the present invention, the information can be correctly recorded and reproduced even in such a state that two recording marks having the shortest mark length are present in the spot of the laser beam. Namely, in the information-recording medium of the present invention, the information can be correctly recorded and reproduced even when the following relationship holds among the wavelength λ of the laser beam, the numerical aperture NA of the objective lens, and a shortest mark length L representing the length of a shortest recording mark to be recorded on the information-recording medium:

0.25≦L/(λ/NA)≦0.40.

In the information-recording medium of the present invention, when random pattern information including signals having lengths of 2 T to 11 T is recorded on the information-recording medium, a reproduced signal waveform is obtained in which the following relationship is established:

−0.10≦[(I_{11H}+I_{11L})/2−(I_{2H}+I_{2L})/2]/(I_{11H}−I_{11L})≦0.10,

provided that T is a channel clock period, I_{11H} and I_{11L} are a high level value and a low level value of a reproduced signal of an 11 T signal respectively, and I_{2H} and I_{2L} are a high level value and a low level value of a reproduced signal of a 2 T signal respectively.

The parameter [(I_{11H}+I_{11L})/2−(I_{2H}+I_{2L})/2]/(I_{11H}−I_{11L}) represents the asymmetry of the reproduced signal, and expresses the balance of the 2 T mark length with respect to the 11 T mark length. As the absolute value of the parameter is closer to 0 (zero), it is easier to detect the 2 T signal level. That is, the parameter expresses the quality of the signal having the shortest mark length 2 T. As the absolute value of the parameter is smaller, the quality of the signal having the shortest mark length 2 T becomes more satisfactory. On the other hand, as the absolute value of the parameter is smaller, the linearity is more easily maintained between the mark length and the amplitude of the reproduced signal.

In the information-recording medium of the present invention, it is preferable that the information-recording medium further comprises first and second substrates, the first and second recording layers are provided on the first and second substrates respectively, the information-recording medium has a disk-shaped form, a concentric or spiral-shaped groove is formed on each of the first and second substrates, at least one of the groove and an inter-groove portion is used as a recording track, and at least one of the groove and the inter-groove portion is meandered. Further, in this case, it is preferable that a track pitch TP of the recording track is within a range of 0.6×(λ/NA) to 0.8×(λ/NA). In particular, when the wavelength X of the laser beam to be used for the information-recording medium of the present invention is λ=400 to 410 nm, it is preferable that the numerical aperture NA of the objective lens is NA=0.6 to 0.65, and the track pitch TP is not more than 0.4 μm. According to the verifying experiment performed by the inventors, it has been found out that the satisfactory recording and reproduction characteristic is obtained even in such a structure as described above.

In the information-recording medium of the present invention, it is preferable that the information-recording medium further comprises first and second substrates, the first and second recording layers are provided on the first and second substrates respectively, the information-recording medium has a disk-shaped form, a concentric or spiral-shaped groove is formed on each of the first and second substrates, and both of the groove and an inter-groove portion are used as recording tracks. In this case, it is preferable that a track pitch TP of the recording tracks is within a range of 0.5×(λ/NA) to 0.6×(λ/NA). In particular, when the wavelength λ of the laser beam to be used for the information-recording medium of the present invention is λ=400 to 410 nm, it is preferable that the numerical aperture NA of the objective lens is NA=0.6 to 0.65, and the track pitch TP is not more than 0.34 μm.

According to the verifying experiment performed by the inventors, it has been found out that satisfactory recording and reproduction characteristic is obtained even when the information-recording medium of the present invention has such a structure as described above. Specifically, the inventors have found out, through the verifying experiment, that the satisfactory recording and reproduction characteristic is obtained with respect to the information-recording medium of the present invention wherein the track pitch TP of the recording track is within the range of 0.5×(λ/NA) to 0.6×(λ/NA). In particular, the inventors have found out that the more satisfactory recording and reproduction characteristic is obtained under the condition in which the wavelength λ of the laser beam is λ=400 to 410 nm, the numerical aperture NA of the objective lens is NA=0.6 to 0.65, and the track pitch TP is not more than 0.34 μm.

In the information-recording medium of the present invention, it is preferable that the information-recording medium further comprises first and second heat-diffusing layers each of which is provided on a side, of one of the first and second recording layers, opposite to the light-incident side of the laser beam. In the information-recording medium of the present invention, the reliability in relation to the multiple times of rewriting is improved by providing the heat-diffusing layers each on the side, of one of the respective recording layers, opposite to the light-incident side of the laser beam.

In the information-recording medium of the present invention, it is preferable that a thickness of the first recording layer is 5 to 10 nm, and a thickness of the first heat-diffusing layer is 7 to 12 nm.

The inventors have found out through the verifying experiment that when the thickness of the first recording layer is made to be not more than 10 nm, then the transmittance of the first recording layer is successfully made to be not less than 50%, and the recording can be performed in the second recording layer without causing any problem. Further, the inventors have found out that when the thickness of the first recording layer is made to be thinner than 5 nm, then the contrast of the crystal-amorphous is decreased in the first recording layer, and the recording and reproduction characteristic is deteriorated.

Further, the inventors have found out that when the thickness of the first heat-diffusing layer is made to be not more than 12 nm, then the transmittance of the first recording layer is successfully made to be not less than 50%, and the recording can be performed also in the second recording layer without causing any problem. Further, the inventors have confirmed that when the first heat-diffusing layer is made to be thinner than 7 nm, then the heat accumulated in the first recording layer during the information recording cannot be released quickly via the first heat-diffusing layer, the shape of the recording mark is distorted, and the recording and reproduction characteristic is greatly deteriorated.

In the information-recording medium of the present invention, it is preferable that a thickness of the second recording layer is 7 to 12 nm. The inventors have found out through the verifying experiment that when the thickness of the second recording layer is made to be not more than 12 nm, the reliability of the information-recording medium is improved in relation to the multiple times of rewriting. It is considered that this feature is obtained for the following reason that, when the thickness of the recording layer is thinned, it is possible to suppress the phenomena including, for example, segregation, composition fluctuation, and flowing of the recording layer material which would be otherwise caused during the multiple times of rewriting. Further, the inventors have found out that when the thickness of the second recording layer is made to be thinner than 7 nm, then the contrast of the crystal-amorphous is decreased in the second recording layer, and the recording and reproduction characteristic is deteriorated.

In the information-recording medium of the present invention, it is preferable that the information-recording medium further comprises a first interface layer which is arranged to be in contact with at least one surface of the first recording layer, and a second interface layer which is arranged to be in contact with at least one surface of the second recording layer. The inventors have found out that it is possible to improve the reliability in relation to the multiple times of rewriting even when the interface layer is provided in contact with at least one surface of each of the recording layers.

In the Bi—Ge—Te-based phase-change material to be used for the information-recording medium of the present invention, instead of using Ge, it is also allowable to use Si, Sn, Pb etc. as homologous elements to Ge. Further, it is also allowable to add an appropriate amount of Si, Sn, and/or Pb, etc. By adding Si, Sn, and/or Pb, etc. in an appropriate amount, it is possible to easily adjust the adaptable linear velocity range. That is, regarding the composition of the material forming the second recording layer, it is also allowable to use, as the material for the second recording layer, a material of which base material is the Bi—Ge—Te-based phase-change material within the range surrounded by the respective points [B2, C2, D2, D6, C6, B6] described above on the triangular composition diagram having the apexes of Bi, Ge, and Te and has a composition in which a part of Ge is substituted with at least one element among Si, Sn, and Pb. As for the material forming the first recording layer, with respect to the foregoing composition of the second recording layer, it is also allowable to use a material of which base material is the Bi—Ge—Te-based phase-change material having the composition in which the difference (α−δ) between the composition α of Bi contained in the first recording layer and the composition δ of Bi contained in the second recording layer is −1.0 to 3.0 at. %. and has a composition in which a part of Ge is substituted with at least one element among Si, Sn, and Pb

In the Bi—Ge—Te-based recording layer material to be used for the information-recording medium of the present invention, instead of Bi, it is also allowable to use Sb as a homologous element to Bi. Further, it is also allowable to add an appropriate amount of Sb. By adding Sb in an appropriate amount, it is possible to easily adjust the adaptable linear velocity range. That is, in relation to the composition of the material forming the second recording layer, it is also allowable to use, as the material for the second recording layer, a material of which base material is the Bi—Ge—Te-based phase-change material within the range surrounded by the respective points [B2, C2, D2, D6, C6, B6] described above on the triangular composition diagram having the apexes of Bi, Ge, and Te and has a composition in which a part of Bi is substituted with Sb. As for the material forming the first recording layer, with respect to the foregoing composition of the second recording layer, it is also allowable to use a material of which base material is the Bi—Ge—Te-based phase-change material having the composition in which the difference (α−δ) between the composition α of Bi contained in the first recording layer and the composition δ of Bi contained in the second recording layer is −1.0 to 3.0 at. % and has a composition in which a part of Bi is substituted with Sb.

In the Bi—Ge—Te-based recording layer material to be used for the information-recording medium of the present invention, it is also allowable to use a recording layer material having such a composition that a part of Ge is substituted with at least one element among Si, Sn, and Pb, and a part of Bi is substituted with Sb. That is, in relation to the composition of the material forming the second recording layer, it is also allowable to use, as the material for the second recording layer, a material of which base material is the Bi—Ge—Te-based phase-change material within the range surrounded by the respective points [B2, C2, D2, D6, C6, B6] described above on the triangular composition diagram having the apexes of Bi, Ge, and Te and has a composition in which a part of Ge is substituted with at least one element among Si, Sn, and Pb and a part of Bi is substituted with Sb, while using the base material of. As for the material forming the first recording layer, in relation to the foregoing composition of the second recording layer, it is also allowable to use a material of which base material is the Bi—Ge—Te-based phase-change material having the composition in which the difference (α−δ) between the composition α of Bi contained in the first recording layer and the composition δ of Bi contained in the second recording layer is −1.0 to 3.0 at. %. and has a composition in which a part of Ge is substituted with at least one element among Si, Sn, and Pb and at least a part of Bi is substituted with Sb.

Further, it is also allowable to add B to the Bi—Ge—Te-based recording layer material to be used for the information-recording medium of the present invention. When B is added, the information-recording medium is obtained, wherein the recrystallization is further suppressed, and the excellent performance is exhibited.

In the information-recording medium of the present invention, it is preferable that the information-recording medium further comprises a first interface layer which is arrange to be in contact with at least one surface of the first recording layer, and a second interface layer which is arranged to be in contact with at least one surface of the second recording layer. The inventors have found out that it is possible to improve the reliability in relation to the multiple times of rewriting even when the interface layer is provided in contact with at least one surface of each of the recording layers.

In the information-recording medium of the present invention, it is also allowable to provide a nucleation layer, which contains Bi₂Te₃, SnTe, and/or PbTe, etc., adjacently to each of the recording layers. In this case, the effect to suppress the recrystallization is further improved.

In the information-recording medium of the present invention, the effect of the present invention is not lost, even when any impurity entered into and is mixed in the medium, provided that the atomic % of any impurity is within 1%, and that the relationship of the composition is maintained such that the composition of the second recording layer is within the composition range (range surrounded by B2, C2, D2, D6, C6, and B6) described above and the difference (α−δ) between the composition α of Bi contained in the first recording layer and the composition δ of Bi contained in the second recording layer is −1.0 to 3.0 at. %.

In this specification, the information-recording medium of the present invention is expressed as “phase-change optical disk” or merely “optical disk” in some cases. However, as for the information-recording medium of the present invention, the present invention is applicable to any information-recording medium in which the heat is generated by being irradiated with the energy beam, the change of the atomic arrangement is caused by the heat, and the information is recorded thereby. Therefore, the information-recording medium of the present invention is irrelevant especially to the shape thereof; and the present invention is also applicable, for example, to any information-recording medium including an optical card, etc.

In this specification, the energy beam described above is expressed as “laser beam”, or merely as “light or light beam” in some cases. However, as described above, the effect is obtained with any energy beam provided that the energy beam is capable of generating the heat on the information-recording medium of the present invention. Therefore, it is also allowable to use any energy beam including electron beam, etc.

The information-recording medium of the present invention assumes such a structure that the first substrate is arranged on the light-incident side of the first recording layer. However, it is also allowable that the first substrate is arranged on a side opposite to the light-incident side of the first recording layer, and a protective member such as a protective sheet, which is thinner than the first substrate, is arranged on the light-incident side.

According to the information-recording medium of the present invention, the Bi—Ge—Te-based phase-change material is used for the first and second recording layers, the composition of Bi, Ge, and Te contained in the second recording layer is defined to be within the composition range surrounded by the following respective points on the triangular composition diagram of Bi, Ge, and Te, and the difference (α−δ) between the composition α of Bi contained in the first recording layer and the composition δ of Bi contained in the second recording layer is −1.0 to 3.0 at. %. Therefore, even when the information is recorded and reproduced under the condition of 46.5 nsec≦(λ/NA)/V≦116.0 nsec (provided that λ=410 to 420 nm is given) (for example, when the information is recorded and reproduced on HD DVD at a speed ranging from the standard speed (1× speed) to the 2× speed) on the assumption that the wavelength of the laser beam is represented by λ (nm), the numerical aperture of the objective lens collecting the laser beam is represented by NA, and the recording linear velocity is represented by V m/sec, then it is possible to provide the information-recording medium wherein all of the first to fourth problems (shrink of the recording mark, cross-erase, damage by the heat, and rewriting in the first recording layer) can be solved, the reliability of the recording data is high, and the durability is excellent against the repeated data recording:
B2 (Bi_{2.0}, Ge_{47.5}, Te_{50.5})
C2 (Bi_{2.5}, Ge_{48.5}, Te_{49.0})
D2 (Bi_{3.0}, Ge_{50.0}, Te_{47.0})
D6 (Bi_{10.0}, Ge_{50.0}, Te_{40.0})
C6 (Bi_{9.0}, Ge_{44.5}, Te_{46.5})
B6 (Bi_{8.0}, Ge_{40.5}, Te_{51.5})

### BRIEF DESCRIPTION OF THE DRAWINGS

FIG. 1 is a schematic sectional view of an optical disk (two-layered information-recording medium) based on the phase-change recording system manufactured in Example 1.

FIG. 2 is a schematic arrangement view of a recording and reproducing apparatus used to evaluate the optical disk manufactured in Example 1.

FIGS. 3A and 3B show results of evaluation of optical disks manufactured in Example 1.

FIGS. 4A and 4B show results of evaluation of optical disks manufactured in Example 2.

FIGS. 5A and 5B show results of evaluation of optical disks manufactured in Example 3.

FIGS. 6A and 6B show results of evaluation of optical disks manufactured in Comparative Example 1.

FIGS. 7A and 7B show results of evaluation of optical disks manufactured in Comparative Example 2.

FIG. 8 is a triangular composition diagram of the Bi—Ge—Te-based phase-change material, illustrating a preferred composition range of the Bi—Ge—Te-based phase-change material to be used for a second recording layer of the present invention.

FIG. 9 is a triangular composition diagram of the Bi—Ge—Te-based phase-change material, illustrating the most appropriate composition range of the Bi—Ge—Te-based phase-change material to be used for the second recording layer of the present invention.

FIG. 10 shows a relationship between the recording linear velocity and the bit error rate in relation to the second recording layer of the two-layered information-recording medium of the present invention.

FIGS. 11A and 11B show results of evaluation of optical disks manufactured in Example 5.

FIGS. 12A and 12B show results of evaluation of optical disks manufactured in Example 6.

FIGS. 13A and 13B show results of evaluation of optical disks manufactured in Example 7.

FIGS. 14A and 14B show results of evaluation of optical disks manufactured in Comparative Example 3.

FIGS. 15A and 15B show results of evaluation of optical disks manufactured in Comparative Example 4.

FIG. 16 shows a relationship between the recording linear velocity and the bit error rate in relation to a first recording layer of the two-layered information-recording medium of the present invention.

FIGS. 17A and 17B illustrate the principle of the PRML signal processing system.

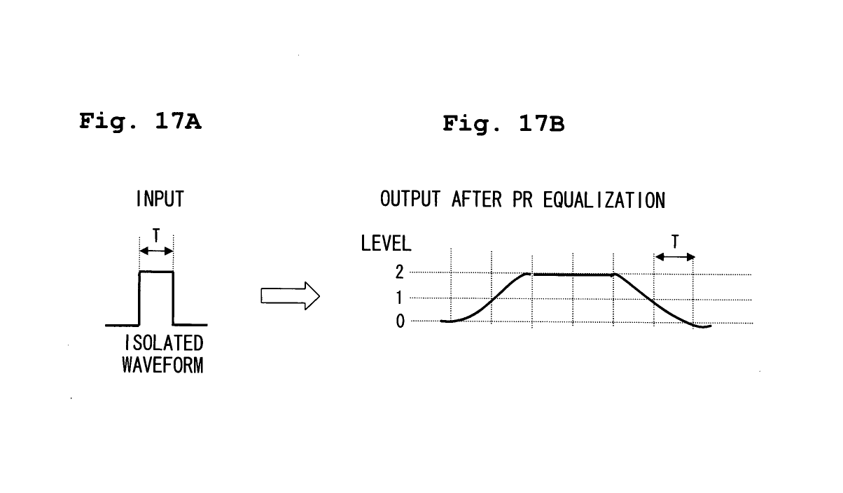

FIG. 18 illustrates the principle of the PRML signal processing system.

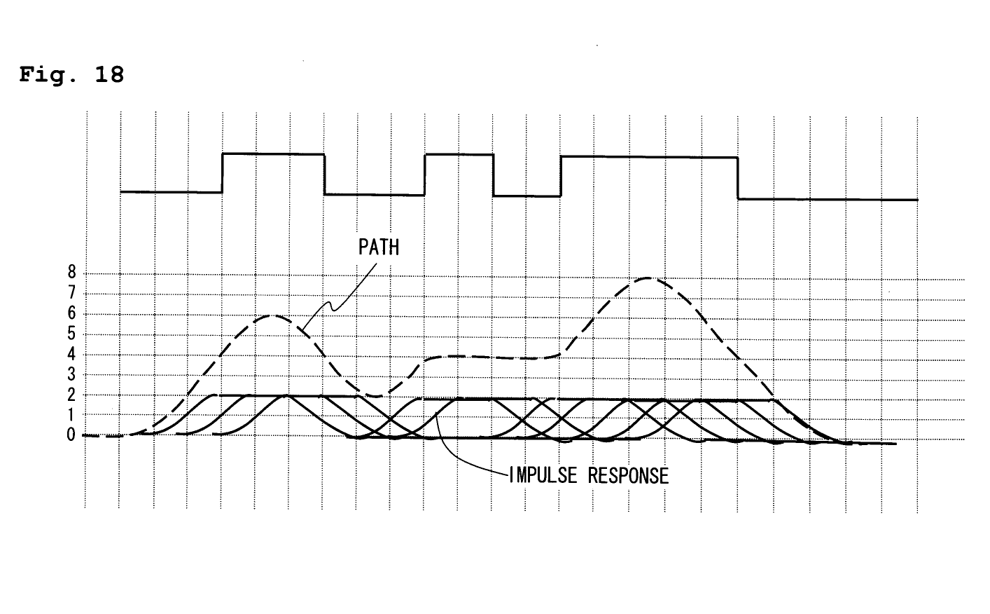

### DESCRIPTION OF THE PREFERRED EMBODIMENTS

Embodiments of the information-recording medium of the present invention will be explained below. However, the present invention is not limited to the embodiments.

### EXAMPLE 1

### Information-Recording Medium and Method for Producing the Same

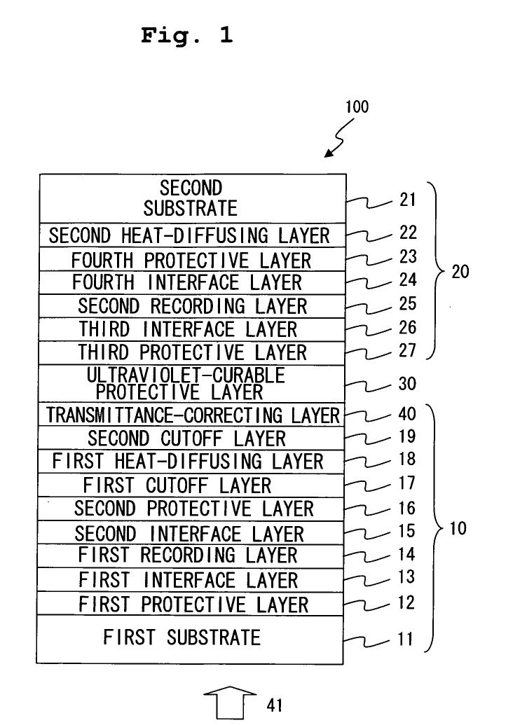

An information-recording medium manufactured in Example 1 is an optical disk of the phase-change type provided with two recording layers. FIG. 1 shows a schematic sectional view illustrating the disk. As shown in FIG. 1, an optical disk 100 manufactured in this embodiment includes a first information section 10, a second information section 20, and an ultraviolet-curable protective layer 30. The optical disk 100 has such a structure that the first information section 10 and the second information section 20 are stuck to each other with the ultraviolet-curable protective layer 30 intervening therebetween. As shown in FIG. 1, in the optical disk 100 of this embodiment, a laser beam 41 comes from the side of the first information section 10.

As shown in FIG. 1, the first information section 10 has such a structure that a first protective layer 12, a first interface layer 13, a first recording layer 14, a second interface layer 15, a second protective layer 16, a first cutoff layer 17, a first heat-diffusing layer 18, a second cutoff layer 19, and a transmittance-correcting layer 40 are successively stacked on a first substrate 11. On the other hand, the second information section 20 has such a structure that a second heat-diffusing layer 22, a fourth protective layer 23, a fourth interface layer 24, a second recording layer 25, a third interface layer 26, and a third protective layer 27 are successively stacked on a second substrate 21. The first information section 10 and the second information section 20 are stuck to each other so that the transmittance-correcting layer 40 of the first information section 10 is opposed to or facing the third protective layer 27 of the second information section 20 with the ultraviolet-curable protective layer 30 intervening therebetween.

The so-called groove recording system, in which the information is recorded only in the groove, is adopted for the optical disk 100 of this embodiment. The groove referred to herein means a portion, forming the protrusion as viewed from the light-incident side or the light-incoming side of the laser beam 41, in the area in which the groove of the substrate is formed.

Next, a method for manufacturing the optical disk 100 of this embodiment will be explained. At first, a method for manufacturing the first information section 10 will be explained.

At first, a substrate made of polycarbonate having a diameter of 120 mm and a thickness of 0.6 mm was used for the first substrate 11. The first substrate 11 was manufactured by the injection molding. A groove was formed in an information recording area having radii ranging from 23.8 mm to 58.6 mm of the first substrate 11 such that the track pitch was 0.40 μm. In this embodiment, the groove recording system is adopted. Therefore, the track pitch referred to in this embodiment is a distance ranging from the center of a predetermined groove track to the center of another groove track adjacent to the predetermined groove track. In this embodiment, a wobble was applied to the track at a cycle or period of 93 channel bits (the track made to wobble at a cycle of 93 channel bits).

Next, (ZnS)₈₀(SiO₂)₂₀ was formed on the first substrate 11 by the sputtering as the first protective layer 12 to have a thickness of 45 nm. Subsequently, (HfO₂)₉₀(Cr₂O₃)₁₀ (mol %) was formed on the first protective layer 12 by the sputtering as the first interface layer 13 to have a thickness of 7 nm.

Subsequently, a Bi—Ge—Te phase-change film having a thickness of 6 nm was formed, as the first recording layer 14, on the first interface layer 13 by the sputtering. In this embodiment, the first recording layer 14 was formed to have such a composition that Ge was added in excess as compared with the composition disposed on the line connecting Ge₅₀Te₅₀ and Bi₂Te₃ on the triangular composition diagram having the apexes of Bi, Ge, and Te (optical disks of the B series). Specifically, targets of Ge₅₀Te₅₀ and Bi₂₁₀Ge_{24.5}Te_{54.5} were used as the sputtering targets, and the first recording layer 14 was formed by the co-sputtering. In this procedure, the sputtering powers applied to the targets respectively were adjusted so that the composition of the first recording layer 14 was Bi_{2.0}Ge_{47.5}Te_{50.5} (Sample No.: B2).

On the first recording layer 14 formed by the method as described above, (Ta₂O₅)₂₀(Cr₂O₃)₈₀ (mol %) was formed by the sputtering, as the second interface layer 15, to have a thickness of 2 nm. Next, on the second interface layer 15, (ZnS)₈₀(SiO₂)₂₀ was formed by the sputtering as the second protective layer 16 to have a thickness of 8 nm. Subsequently, on the second protective layer 16, (Ta₂O₅)₂₀(Cr₂O₃)₈₀ (mol %) was formed by the sputtering as the first cutoff layer 17 to have a thickness of 1 nm. Afterwards, on the first cutoff layer 17 Ag—Ca—Cu was formed by the sputtering as the first heat-diffusing layer 18 to have a thickness of 8 nm. Then, on the first heat-diffusing layer 18, (Ta₂O₅)₂₀(Cr₂O₃)₈₀ (mol %) was formed by the sputtering as the second cutoff layer 19 to have a thickness of 1 nm. Further, on the second cutoff layer 19, (ZnS)₈₀(SiO₂)₂₀ was formed by the sputtering as the transmittance-correcting layer 40 to have a thickness of 22 nm.

Next, a method for manufacturing the second information section 20 will be explained. At first, a substrate made of polycarbonate having a dimension same as that of the first substrate 11 was used for the second substrate 21. The second substrate 21 was manufactured in accordance with a method same as that for the first substrate 11. A groove was formed in an information recording area having radii ranging from 23.8 mm to 58.6 mm of the second substrate 21 so that the track pitch was 0.40 μm. A wobble was applied to the track at a cycle or period of 93 channel bits (the track was wobbled at a cycle of 93 channel bits).

Subsequently, on the second substrate 21, Ag—Ca—Cu was formed by the sputtering as the second heat-diffusing layer 22 to have a thickness of 100 nm. Next, on the second heat-diffusing layer 22, (ZnS)₈₀(SiO₂)₂₀ was formed by the sputtering as the fourth protective layer 23 to have a thickness of 20 nm. Afterwards, on the fourth protective layer 23, (Ta₂O₅)₆₀(Cr₂O₃)₄₀ (mol %) was formed by the sputtering as the fourth interface layer 24 to have a thickness of 2 nm.

Then, on the fourth interface layer 24, a Bi—Ge—Te phase-change film was formed by the sputtering as the second recording layer 25 to have a thickness of 10 nm. Specifically, the Bi—Ge—Te phase-change film having the composition (Bi_{2.0}Ge_{47.5}Te_{50.5}) which is same as that of the first recording layer 14, was formed in the same manner as the first recording layer 14.

On the second recording layer 25 formed by the method as described above, (HfO₂)₉₀(Cr₂O₃)₁₀ (mol %) was formed by the sputtering as the third interface layer 26 to have a thickness of 7 nm. Then, on the third interface layer 26, (ZnS)₈₀(SiO₂)₂₀ was formed by the sputtering as the third protective layer 27 to have a thickness of 60 nm.

Next, an explanation will be made about a method for sticking the first information section 10 and the second information section 20 manufactured by the methods as described above. At first, a UV resin as the UV-curable protective layer 30 was coated on the transmittance-correcting layer 40 of the first information section 10; and the second information section 20 was placed on the UV-curable protective layer 30 so that a side, of the second information section 20, on the third protective layer 27 is opposed to or facing the transmittance-correcting layer 40 of the first information section 10. Subsequently, the UV irradiation was performed through the transparent substrate to cure the UV resin, to thereby stick the first information section 10 and the second information section 20 to each other. The optical disk 100 shown in FIG. 1 was obtained in accordance with the production method as described above.

In this embodiment, other optical disks 100 were further manufactured, in which both of the compositions of the first recording layer 14 and the second recording layer 25 were Bi_{3.0}Ge_{46.5}Te_{50.5} (Sample No.: B3); Bi_{5.0}Ge_{44.0}Te_{51.0} (Sample No.: B4); Bi₇₀Ge_{46.5}Te_{50.5} (Sample No.: B5); and Bi_{8.0}Ge_{40.5}Te_{51.5} (Sample No.: B6). For the purpose of comparison, yet other optical disks 100 were also manufactured, in which the compositions were Bi_{1.0}Ge_{49.0}Te_{50.0} (Sample No.: B1); and Bi_{9.0}Ge_{39.0}Te_{52.0} (Sample No.: B7).

A laser light (laser beam) of an elliptical beam, which had a wavelength of 810 nm, a long diameter of the beam spot of 96 μm, and a short diameter of 1 μm, was radiated onto the various optical disks 100 obtained in accordance with the production method as described above, to initialize the first and second recording layers.

In this embodiment, the information recording and reproducing or playback test was performed for the various optical disks 100 having the different compositions of the first recording layer 14 and the second recording layer 25 obtained in accordance with the production method as described above, to evaluate the characteristic of the second recording layer 25.

### Information-Recording/Reproducing Apparatus

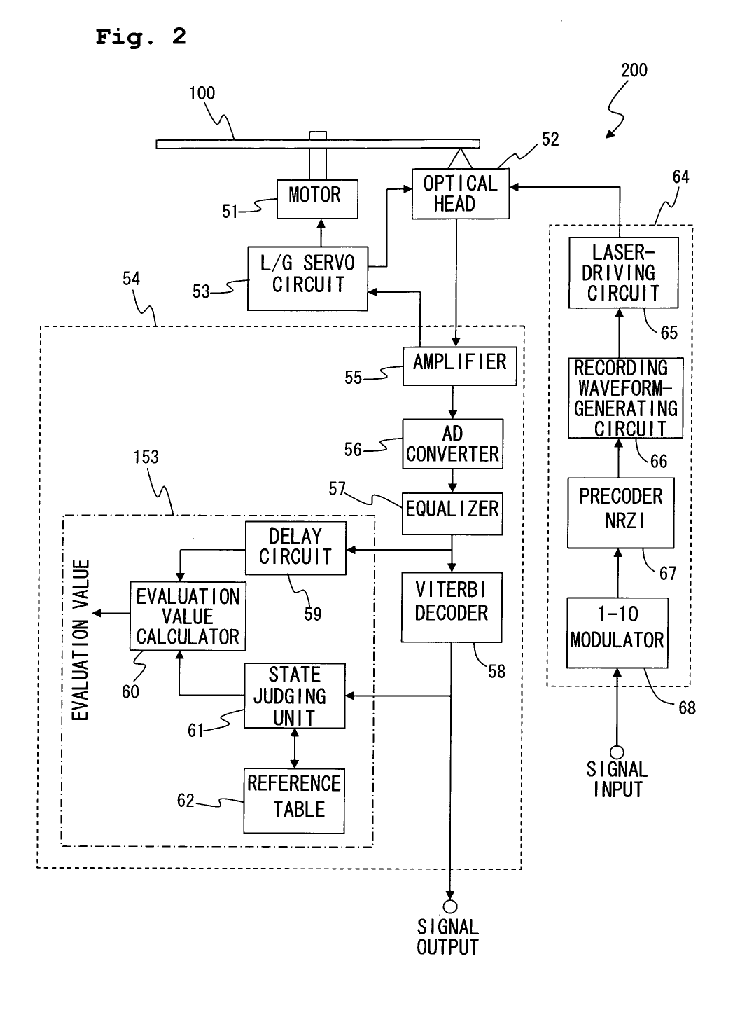

An explanation will now be made about the information-recording/reproducing apparatus for performing the recording and reproduction of the information on the various optical disks manufactured in this embodiment. FIG. 2 shows a schematic arrangement view of the information-recording/reproducing apparatus used in this embodiment. As shown in FIG. 2, an information-recording/reproducing apparatus 200 used in this embodiment principally includes a motor 51 which rotates the optical disk 100 manufactured in this embodiment, an optical head 52 which radiates the laser beam onto the optical disk 100, an L/G servo circuit 53 which performs the tracking control, a reproduced signal processing system 54, and a recording signal processing system 64.

As shown in FIG. 2, the reproduced signal processing system 54 includes an amplifier 55 which amplifies the reproduced signal, an analog/digital converter 56 which converts the amplified reproduced signal into a binary signal, an equalizer 57 which performs an equalizing process for the reproduced signal waveform, a Viterbi decoder 58 which decodes an information corresponding to the signal for which the waveform equalization has been performed, and an evaluation value calculation unit 153 which calculates the bit error rate.

As shown in FIG. 2, the evaluation value calculation unit 153 is constructed of a delay circuit 59, a state judging device 61, a reference table 62, and an evaluation value calculator 60. The delay circuit 59 is a delay unit which performs time adjustment for the data inputted from the equalizer 57. The state judging device 61 compares the output data from the Viterbi decoder 58 with an erroneous pattern stored in the reference table 62, and inputs the result of comparison into the evaluation value calculator 60. The evaluation value calculator 60 calculates the bit error rate by using the input data from the equalizer 57 and the input data from the state judging device 61.

As shown in FIG. 2, the recording system processing system 64 is constructed of a 1-10 modulator 68 which modulates the inputted signal in a predetermined modulation system, a precoder 67 which avoids or stops any erroneous data transmission during the decoding, a recording waveform-generating circuit 66 which generates the recording waveform, and a laser-driving circuit 65 which controls the light emission of the laser beam.

The optical head 52 used in this embodiment is provided with a semiconductor laser having a wavelength of 405 nm, and an objective lens having a numerical aperture NA of 0.65 (not shown). In general, when the laser beam having a wavelength λ is collected with the objective lens having a numerical aperture NA, the spot diameter of the laser beam is approximately 0.9×λ×NA. Therefore, in this embodiment, the spot diameter of the laser beam is about 0.6 μm. However, in this embodiment, the polarization of the laser beam is the circular polarization. Further, in this embodiment, since the track pitch TP is 0.40 μm, a relationship of TP=0.64×(λ/NA) holds among the track pitch TP, the wavelength λ, and the numerical aperture NA.

The optical disk 100 manufactured in this embodiment is an optical disk of the groove recording system. Therefore, the information-recording/reproducing apparatus 200 shown in FIG. 2 is also adapted to the groove recording system. In the information-recording/reproducing apparatus 200 of this embodiment, the tracking can be arbitrarily selected for the land and the groove by the L/G servo circuit 53 shown in FIG. 2.

The operation of the information-recording/reproducing apparatus 200 will be explained below with reference to FIG. 2. As for the motor control method to be adopted when the recording and reproduction are performed, the ZCLV system was adopted. In the ZCLV system, the number of revolutions of the disk is changed for every zone in which the recording and/or reproduction is performed. In this embodiment, when the information was recorded, the information was recorded on the optical disk 100 in accordance with the ETM, RLL (1, 10) modulation system by using the mark edge system. In this modulation system, the information is recorded with mark lengths of 2 T to 11 T. Here, “T” represents the clock cycle or period during the information recording. In this embodiment, T=15.4 ns was provided. That is, in this embodiment, the shortest mark length 2 T is about 0.20 μm, and the longest mark length 11 T is about 1.12 μm. That is, in this embodiment, the shortest mark length 2 T is about ⅓ of the spot diameter of the laser beam (about 0.6 μm). In this embodiment, the recording linear velocity of 6.61 m/sec is the 1× speed; and the recording speed of the 2× speed is 13.22 m/sec.

At first, a signal, which is required for the information recording, is inputted from the outside of the recording apparatus into the 1-10 modulator 68. Next, the signal inputted into the 1-10 modulator 68 is modulated in accordance with the modulation system described above, and digital signals of 2 T to 11 T are outputted. Then, the signals are converted into NRZI codes by the precoder 67, and the digital signals of 2 T to 11 T outputted from the 1-10 modulator 68 are inputted into the recording waveform-generating circuit 66.

In the recording waveform-generating circuit 66, multi-pulse recording waveform, which is required for the laser beam radiation during the information recording, is generated based on the inputted digital signals of 2 T to 11 T. In this embodiment, a high power level area of the multi-pulse recording waveform was formed of a series of pulse sequence composed of high power pulses each having a width of about T/2 and low power pulses each having a width of about T/2 and formed between the high power pulses. An area, located between the series of pulse sequence of the multi-pulse recording waveform, was composed of pulses each having an intermediate power level. In this procedure, a pulse intensity at the high power level for forming the recording mark in the recording layer (making conversion into the amorphous) and a pulse intensity at the intermediate power level for crystallizing the recording mark were adjusted to have optimum values for each of the optical disks on which the recording and reproduction was to be performed.

In the recording waveform-generating circuit 66, the digital signal waveform of 2 T to 11 T was alternately adapted to “0” and “1” in a chronological order. In the case of “0”, the laser pulse at the intermediate power level was radiated. In the case of “1”, the series of pulse sequence, which was composed of the high power pulses and the low power pulses as described above, was radiated. In this procedure, a portion on the optical disk 100, which is irradiated with the laser pulse at the intermediate power level, is crystallized. Another portion, irradiated with the series of pulse sequence composed of the high power pulses and the low power pulses as described above, is changed into the amorphous (mark portion). Further, the recording waveform-generating circuit 66 has the multi-pulse waveform table corresponding to the system (adapted type recording waveform control) in which the leading pulse width and the trailing pulse width of the multi-pulse waveform are changed depending on the space lengths provided before and after the mark portion upon forming the series of pulse sequence composed of the high power pulses and the low power pulses as described above. Accordingly, the multi-pulse recording waveform is generated, which makes it possible to exclude all the possible influence of the inter-mark thermal interference generated between the marks.

Subsequently, the multi-pulse recording waveform, generated in the recording waveform-generating circuit 66, is transferred to the laser-driving circuit 65. The laser-driving circuit 65 controls the light emission of the semiconductor laser included in the optical head 52 based on the inputted multi-pulse recording waveform. The laser beam radiated from the semiconductor laser is focused, by the objective lens included in the optical head 52, onto the recording layer of the optical disk 100 to radiate the laser beam at the timing adapted to the multi-pulse recording waveform. In this way, the information was recorded.

Next, an explanation will be made about the operation for reproducing the information having been recorded as described above. At first, the laser beam is radiated from the optical head 52 onto the recording mark on the optical disk 100. Reflected light beams, which are obtained from the recording mark and a portion other than the recording mark (non-recorded portion), are detected by the optical head 52 to obtain the reproduced signal. The amplitude of the reproduced signal is amplified at a predetermined gain by the amplifier 55. The amplified reproduced signal is converted into the digital reproduced signal by the AD converter 56. The digital reproduced signal is equalized by the equalizer 57 into a waveform (reproduced signal sequence) corresponding to the PR characteristic to be used, and is fed to the Viterbi decoder 58 and the evaluation value calculation unit 153.

In the Viterbi decoder 58, the waveform, adapted to the PR characteristic inputted from the equalizer 57, is decoded into binary identification data. The identification data is subjected to a processing including, for example, demodulation, error correction, etc., if necessary, thereby completing the reproduction of the recorded information. The identification data, outputted from the Viterbi decoder 58, is also fed to the evaluation value calculation unit 153. On the other hand, the waveform, adapted to the PR characteristic and fed from the equalizer 57 to the evaluation value calculation unit 153, is inputted via the delay circuit 59 into the evaluation value calculator 60.

In the evaluation value calculation unit 153, the bit error rate is calculated by using the waveform adapted to the PR characteristic and inputted from the equalizer 57 and the identification data inputted from the Viterbi decoder 58. A method for calculating the bit error rate in the evaluation value calculation unit 153 will be explained in detail below.

### Method for Calculating Bit Error Rate

At first, in the state judging device 61, reference is made to the previously prepared pattern of the reference table 62 to make comparison with the identification data inputted from the Viterbi decoder 68. In the reference table 62, there are prepared correct patterns and ideal signals thereof assumed for the respective patterns of the identification data inputted from the Viterbi decoder 68, erroneous patterns and ideal signals thereof assumed for the respective patterns of the identification data, and the Euclidean distances between the correct patterns and the erroneous patterns, respectively (hereinafter referred to as “E_{T,F}”).

When a pattern, which is the same as the identification data inputted into the state judging device 61, is present in the correct patterns included in the reference table 62, then the correct pattern and the ideal signal thereof previously prepared in the reference table 62, the erroneous pattern and the ideal signal thereof, and the Euclidean distance E_{T,F} between the correct pattern and the erroneous pattern are inputted into the evaluation value calculator 60 via the state judging device 61. On the other hand, when a pattern, which is same as the identification data inputted into the state judging device 61, is absent in the reference table 62, then the same processing is performed for data which is inputted next.

The Euclidean distance means the distance between two signals and assuming that the two signals are S_{A} and S_{B}, the Euclidean distance is defined as E=Σ(S_{A}−S_{B})². The Euclidean distance will now be specifically explained by using numerical expressions. It is assumed that the PR-equalized signal sequences S_{A} and S_{B} are represented by the following amplitude sequences:

S_{A}=[5.9, 6.0, 6.1, 4.9, 3.0, 0.9, 0.1, 0.0, 0.1]

S_{B}=[6.0, 5.9, 6.0, 5.0, 3.1, 1.0, 0.0, 0.0, 0.0]

The Euclidean distance E between the two reproduced signals is calculated as follows in accordance with the definition described above:

E=(6.0−5.9)²+(6.0−5.9)²+(6.1−6.0)²+(5.0−4.9)²+(3.1−3.0)²+(1.1−1.0)²+(0.1−0)²+(0.1−0)²=0.08

As described above, the calculation of the Euclidean distance E is the calculation of the error between the two reproduced signals.

Subsequently, the evaluation value calculator 60 calculates an Euclidean distance (error) E_{TS} between the ideal signal of the correct pattern inputted from the reference table 62 via the state judging device 61 and the reproduced signal inputted from the equalizer 57 via the delay circuit 59, and calculates an Euclidean distance (error) E_{FS} between the ideal signal of the erroneous pattern and the reproduced signal. The errors (Euclidean distances) between the actually detected reproduced signal and all of the paths assumed for the reproduced signal are calculated; and a path, among the paths, in which the calculation error is the smallest, is selected from the paths, and the information is demodulated.

Subsequently, the bit error rate is calculated by using the Euclidean distances E_{FS} and E_{TS} calculated by the evaluation value calculator 60 and the Euclidean distance E_{T,F} between the correct pattern and the erroneous pattern inputted from the reference table 62 via the state judging device 61. In this embodiment, the bit error rate is calculated by a method in accordance with the HD DVD-Rewritable standard by using the distribution of |E_{FS}−E_{TS}|/E_{T,F}.

At first, the fact that the distribution of |E_{FS}−E_{TS}|/Eⱼ (Eⱼ: Euclidean distance between the correct pattern and the erroneous pattern) is a normal distribution in the statistics is utilized, and an average value i and the square root of the variance (standard deviation) σ of |E_{FS}−E_{TS}|/E_{T,F} and the probability density function of the normal distribution are used to determine a characteristic in which the distribution of |E_{FS}−E_{TS}|/E_{T,F} is approximated by the probability density function. Subsequently, a portion, of the determined characteristic, in which E_{TS}>E_{FS} is given (portion of the characteristic in which the values on the X axis are not more than 0) is integrated. Specifically, the integral value Erf(0) is calculated by using the following expression (1). Note that the Viterbi decoder 58 selects the erroneous pattern at the portion in which E_{TS}>E_{FS} is given in the characteristic obtained by approximating the distribution of |E_{FS}−E_{TS}|/E_{T,F} with the probability density function.

$$Erf ( 0 ) = {\int }_{- ∞}^{0} \frac{exp \{ - {( x - μ )}^{2} / 2 {σ}^{2} \}}{σ \cdot \sqrt{2 π}} d x \qquad ( 1 )$$

Subsequently, Erf(0)'s, which are obtained by the expression (1) described above, are cumulated to calculate the bit error rate in accordance with the following expression (2).

SbER=ΣC_{T}·Erf(0)·H_{T,F} (2)

C_{T} in the expression (2) represents the occurrence probability of the correct pattern in each state transition. C_{T} is (number of correct patterns in certain state transition)/(number of all assumable patterns in certain state transition).

In the above-described expression (2), H_{T,F} is the Hamming distance between the correct pattern and the erroneous pattern. The Hamming distance represents a distance between the objective codes. For example, when the correct pattern is [1, 1, 1, 1, 1, 1, 0, 0, 0, 0, 0, 0] and the erroneous pattern is [1, 1, 1, 1, 1, 1, 1, 0, 0, 0, 0, 0], then a Hamming distance H_{T,F} between the both codes is H_{T,F}=(1−1)²+(1−1)²+(1−1)²+(1−1)²+(1−1)²+(1−1)²+(1−0)²+(0−0)²+(0−0)²+(0−0)²+(0−0)²+(0−0)²=1.

In this embodiment, the bit error rate SbER was calculated in accordance with the method described above. When the bit error rate is measured in this embodiment, a random pattern including 2 T to 11 T was recorded in accordance with the HD DVD-Rewritable standard. In this embodiment, the PR (1, 2, 2, 2, 1) characteristic was used as the PR characteristic.

### Evaluation of Second Recording Layer

At first, in order to evaluate the recording/erasing performance of the second recording layer of each of the various optical disks 100 provided with the first and second recording layers having the different compositions as manufactured in this embodiment, each of the optical disks 100 was set in the information-recording/reproducing apparatus 200 shown in FIG. 2 to measure the bit error rates of the second recording layer (error rates after rewriting the random pattern ten times) in the 1× speed recording and in the 2× speed recording on HD DVD. Specifically, the random pattern was recorded one by one in a direction directed from the inner circumference to the outer circumference of continuous five tracks, and then the bit error rate was measured on the center track of the five tracks.

In order to evaluate the signal quality of the recording mark corresponding to the shortest mark length 2 T, the asymmetry of the reproduced signal was measured in accordance with the following expression:

Asymmetry=[(I_{11H}+I_{11L})/2−(I_{2H}+I_{2L})/2]/(I_{11H}−I_{11L})

In the expression, I^{11H}: high level (maximum value) of a reproduced signal of the recording mark having the mark length 11 T;

I_{11L}: low level (minimum value) of the reproduced signal of the recording mark having the mark length 11 T;

I_{2H}: high level (maximum value) of a reproduced signal of the recording mark having the mark length 2 T;

I_{2L}: low level (minimum value) of the reproduced signal of the recording mark having the mark length 2 T.

Further, in this embodiment, in order to test the rewriting service life of the second recording layer, the bit error rate was measured after performing the rewriting on the second recording layer in the 1× speed recording and the 2× speed recording. Further, in this embodiment, in order to evaluate the influence of the recrystallization in the recording mark, a single frequency signal of 8 T was recorded at a recording linear velocity (6.61 m/sec) corresponding to the 1× speed of HD DVD and a recording linear velocity (13.22 m/sec) corresponding to the 2× speed of HD DVD to measure the amplitude ratio of the reproduced signals of the information recorded at the respective recording linear velocities (amplitude in the 1× speed recording/amplitude in the 2× speed recording). In this procedure, in order to exclude the influence exerted by the error of the laser power setting, the recording was performed such that the optimum power was 1.7-fold the recording start power.

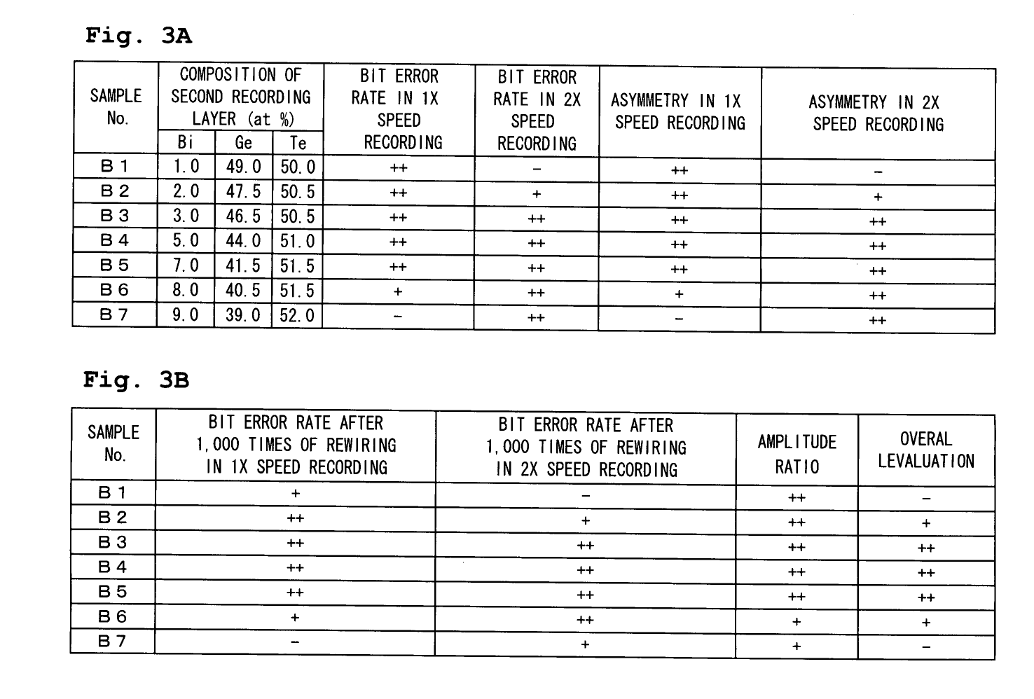

Results of the evaluation in this embodiment are summarized in FIGS. 3A and 3B. Target values of the respective evaluation items shown in FIGS. 3A and 3B are as follows.

(1) bit error rate in 1× speed recording: not more than 5×10⁻⁵;

(2) bit error rate in 2× speed recording: not more than 5×10⁻⁵;

(3) asymmetry: −0.10 to 0.10;

(4) bit error rate after 1,000 times of rewriting: not more than 1×10⁻⁴;

(5) amplitude ratio: not less than 0.85.

In FIGS. 3A and 3B, the evaluation results are expressed by “++”, “+”, and “−”, wherein the evaluation criteria thereof are as follows.

### (1) Bit Error Rate:

++: not more than 1.0×10⁻⁵, +: not more than 5.0×10⁻⁵, −:more than 5.0×10⁻⁵.

### (2) Asymmetry:

++: −0.05 to 0.05, +: −0.10 to 0.10, −: less than −0.10 or more than 0.10.

### (3) Bit Error Rate After 1,000 Times of Rewriting:

++: not more than 5.0×10⁻⁵, +: not more than 1.0×10⁻⁴, −: more than 1.0×10⁻⁴.

### (4) Amplitude Ratio:

++: not less than 0.9, +: not less than 0.85, −: less than 0.85.

### (5) Overall Evaluation:

++: all of the evaluation items are ++, +: “−” is absent and at least one “+” is present in the evaluation items, −: at least one “−” is present in the evaluation items.

As appreciated from FIGS. 3A and 3B, in the second recording layer of Sample B1 (Bi_{1.0}Ge_{49.0}Te_{50.0}), the target values were underachieved in relation to the items of the bit error rate in the 2× speed recording, the asymmetry in the 2× speed recording, and the bit error rate after 1,000 times of rewriting in the 2× speed recording. Therefore, the overall evaluation was “−”.

As shown in FIGS. 3A and 3B, in the second recording layer of Sample B2 (Bi_{2.0}Ge_{47.5}Te_{50.5}), the target values were achieved in relation to all of the items. The evaluation was “++” in relation to the items of the bit error rate in the 1× speed recording, the asymmetry in the 1× speed recording, the bit error rate after 1,000 times of rewriting in the 1× speed recording, and the amplitude ratio. The evaluation was “+” in relation to the remaining items other than the above items. Therefore, the overall evaluation was “+” for the second recording layer of Sample B2.

As shown in FIGS. 3A and 3B, the evaluation was “++” in relation to all of the items in the second recording layers of Sample B3 (Bi_{3.0}Ge_{46.5}Te_{50.5}), Sample B4 (Bi_{5.0}Ge_{44.0}Te_{51.0}), and Sample B5 (Bi_{7.0}Ge_{41.5}Te_{51.5}). The overall evaluation was “++” for Samples B3 and B5.

As shown in FIGS. 3A and 3B, the target values were achieved in relation to all of the items in the second recording layer of Sample B6 (Bi_{8.0}Ge_{40.5}Te_{51.5}). The evaluation was “++” in relation to the items of the bit error rate in the 2× speed recording, the asymmetry in the 2× speed recording, and the bit error rate after 1,000 times of rewriting in the 2× speed recording. The evaluation was “+” in relation to the remaining items other than the above items. Therefore, the overall evaluation was “+” for Sample B6.

As shown in FIGS. 3A and 3B, in the second recording layer of Sample B7 (Bi_{9.0}Ge_{39.0}Te_{52.0}), the target values were underachieved in relation to the items of the bit error rate in the 1× speed recording, the asymmetry in the 1× speed recording, and the bit error rate after 1,000 times of rewriting in the 1× speed recording. Therefore, the overall evaluation was “−” for Sample B7.

According to the results of the measurement as described above, it has been found out that the target values are achieved in relation to all of the evaluation items when the Bi—Ge—Te-based phase-change material, in which the Ge amount is 40.5 to 47.5 at. % and the Bi amount is 2.0 to 8.0 at. % (compositions of Samples B2 to B6), is used as the material for forming the second recording layer in the case of the optical disk of the B series. In particular, the following fact has been found out that when the Bi—Ge—Te-based phase-change material, in which the Ge amount is 41.5 to 46.5 at. % and the Bi amount is 3.0 to 7.0 at. % (compositions of Samples B3 to B5), is used as the materials for forming the first and second recording layers, an optical disk having more excellent performance is obtained in which the evaluation is “++” in relation to all of the evaluation items concerning the second recording layer.

The evaluation as described above was also made for the first recording layers of the various optical disks of this embodiment in the same manner as for the second recording layers described above. As a result, the satisfactory characteristic (overall evaluation: not less than “+”) was obtained for all of Samples B1 to B7 in relation to the first recording layers.

### EXAMPLE 2

In Example 2, the first and second recording layers were formed so that the compositions of the first and second recording layers were such compositions that Ge was added in more excess as compared with those on the composition line of the first and second recording layers of the optical disks of the B series (Example 1) on the triangular composition diagram having the apexes of Bi, Ge, and Te. In this embodiment, the compositions of the first and second recording layers were identical with each other. In Example 2, optical disks were manufactured in the same manner as in Example 1 except that the compositions of the first and second recording layers were changed. In this embodiment also, various optical disks (optical disks of the C series), in which the compositions of the first and second recording layers were different from each other, were manufactured in the same manner as in Example 1.

In this embodiment, targets of Ge₅₀Te₅₀ and Bi_{29.0}Ge_{32.5}Te_{38.5} were used as the sputtering targets, and the first and second recording layers were formed by the co-sputtering. In this procedure, the sputtering powers to be applied to the respective targets were adjusted so that the compositions of the first and second recording layers were the desired compositions. Specifically, the optical disks were manufactured, in which both of the compositions of the first and second recording layers were Bi_{2.5}Ge_{48.5}Te_{49.0} (Sample No.: C2); Bi_{3.5}Ge_{48.0}Te_{48.5} (Sample No.: C3); Bi_{6.0}Ge_{46.5}Te_{47.5} (Sample No.: C4); Bi_{8.0}Ge_{45.0}Te_{47.0} (Sample No.: C5); and Bi_{9.0}Ge_{44.5}Te_{46.5} (Sample No.: C6). In this embodiment, for the purpose of comparison, other optical disks were also manufactured, in which both of the compositions of the first and second recording layers were Bi_{1.5}Ge_{49.0}Te_{49.5} (Sample No.: C1) and Bi_{10.0}Ge_{44.0}Te_{46.0} (Sample No.: C7).

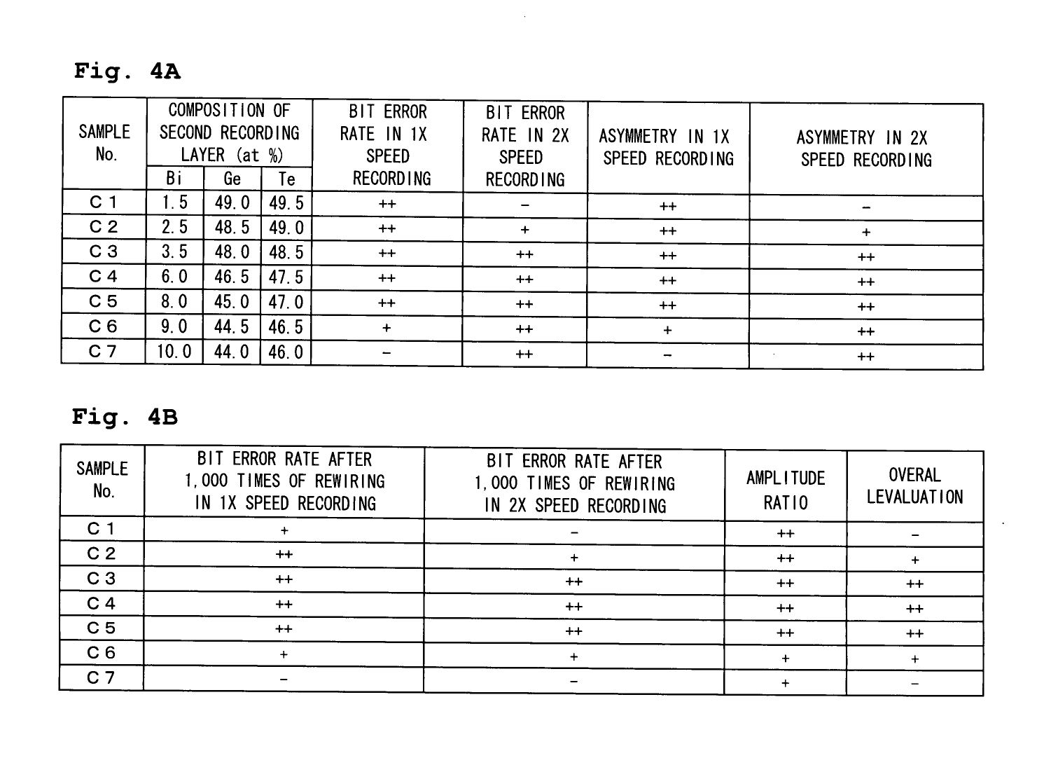

The evaluation was made in the same manner as in Example 1 for the second recording layers of the optical disks of the C series manufactured in this embodiment as well. Obtained results are shown in FIGS. 4A and 4B. FIGS. 4A and 4B show the results of evaluation of the second recording layers. The target values of the respective evaluation items and the evaluation criteria of “++”, “+”, and “−” shown in FIGS. 4A and 4B are the same as those of Example 1.

As appreciated from FIGS. 4A and 4B, in the second recording layer of Sample C1 (Bi_{1.5}Ge_{49.0}Te_{49.5}), the target values were underachieved in relation to the items of the bit error rate in the 2× speed recording, the asymmetry in the 2× speed recording, and the bit error rate after 1,000 times of rewriting in the 2× speed recording. The overall evaluation was “−” for Sample C1.

As shown in FIGS. 4A and 4B, in the second recording layer of Sample C2 (Bi_{2.5}Ge_{48.5}Te_{49.0}), the target values were achieved in relation to all of the evaluation items. The evaluation was “++” in relation to the items of the bit error rate in the 1× speed recording, the asymmetry in the 1× speed recording, the bit error rate after 1,000 times of rewriting in the 1× speed recording, and the amplitude ratio. The evaluation was “+” in relation to the remaining items other than the above items. Therefore, the overall evaluation was “+” in the second recording layer of Sample C2.

As shown in FIGS. 4A and 4B, the evaluation was “++” in relation to all of the evaluation items in the second recording layers of Sample C3 (Bi_{3.5}Ge_{48.0}Te_{48.5}), Sample C4 (Bi_{6.0}Ge_{46.5}Te_{47.5}), and Sample C5 (Bi_{8.0}Ge_{45.0}Te_{47.0}). The overall evaluation was “++” for Samples C3 to C5.

As shown in FIGS. 4A and 4B, the target values were achieved in relation to all of the evaluation items in the second recording layer of Sample C6 (Bi_{9.0}Ge_{44.5}Te_{46.5}). The evaluation was “++” in relation to the items of the bit error rate in the 2× speed recording and the asymmetry in the 2× speed recording. The evaluation was “+” in relation to the remaining items other than the above items. Therefore, the overall evaluation was “+” for Sample C6.

As appreciated from FIGS. 4A and 4B, in the second recording layer of Sample C7 (Bi_{10.0}Ge_{44.0}Te_{46.0}), the target values were underachieved in relation to the items of the bit error rate in the 1× speed recording, the asymmetry in the 1× speed recording, the bit error rate after 1,000 times of rewriting in the 1× speed recording, and the bit error rate after 1,000 times of rewriting in the 2× speed recording. The overall evaluation was “−” for Sample C7.

According to the results of the measurement as described above, it has been revealed that the target values are achieved in relation to all of the evaluation items when the Bi—Ge—Te-based phase-change material, in which the Ge amount is 44.5 to 48.5 at. % and the Bi amount is 2.5 to 9.0 at. % (compositions of Samples C2 to C6), is used as the material for forming the second recording layer in the optical disk of the C series. In particular, the following fact has been found out that, when the Bi—Ge—Te-based phase-change material, in which the Ge amount is 45.0 to 48.0 at. % and the Bi amount is 3.5 to 8.0 at. % (compositions of Samples C3 to C5), is used, an optical disk having the more excellent performance is obtained in which the evaluation is “++” in relation to all of the evaluation items concerning the second recording layer.

The evaluation as described above was also made for the first recording layers of the various optical disks of this embodiment in the same manner as for the second recording layers described above. As a result, the satisfactory characteristic (overall evaluation: not less than “+”) was obtained for all of Samples C1 to C7 in relation to the first recording layers.

### EXAMPLE 3

In Example 3, the first and second recording layers were formed so that the compositions of the first and second recording layers were such compositions that Ge was added in more excess as compared with those on the composition line of the first and second recording layers of the optical disks of the C series (Example 2) on the triangular composition diagram having the apexes of Bi, Ge, and Te. In this embodiment, the compositions of the first and second recording layers were identical with each other. In Example 3, the optical disks were manufactured in the same manner as in Example 1 except that the compositions of the first and second recording layers were changed. Also in this embodiment, various optical disks (optical disks of the D series), in which the compositions of the first and second recording layers were different from each other, were manufactured.

In this embodiment, targets of Ge₅₀Te₅₀ and Bi_{23.0}Ge_{50.0}Te_{27.0} were used as the sputtering targets, and the first and second recording layers were formed by the co-sputtering. In this procedure, the sputtering powers to be applied to the respective targets were adjusted so that the compositions of the first and second recording layers were the desired compositions. Specifically, the optical disks were manufactured, in which the compositions of the first and second recording layers were Bi_{3.0}Ge_{50.0}Te_{47.0} (Sample No.: D2); Bi_{4.0}Ge_{50.0}Te_{46.0} (Sample No.: D3); Bi_{6.0}Ge_{50.0}Te_{44.0} (Sample No.: D4); Bi_{9.0}Ge_{50.0}Te_{41.0} (Sample No.: D5); and Bi_{10.0}Ge_{50.0}Te_{40.0} (Sample No.: D6). In this embodiment, for the purpose of comparison, other optical disks were also manufactured in which the compositions of the recording layers were Bi_{2.0}Ge_{50.0}Te_{48.0} (Sample No.: D1); and Bi_{11.0}Ge_{50.0}Te_{39.0} (Sample No.: D7).

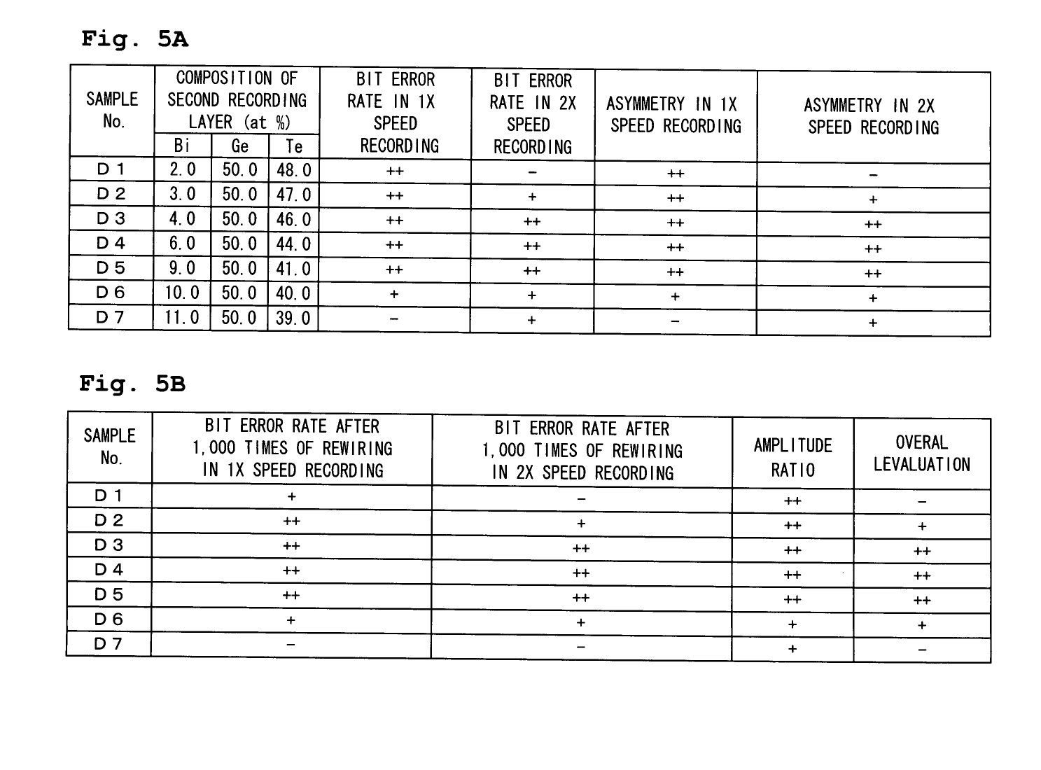

The evaluation was made in the same manner as in Example 1 for the second recording layers of the optical disks of the D series manufactured in this embodiment as well. Obtained results are shown in FIGS. 5A and 5B. FIGS. 5A and 5B show the results of evaluation of the second recording layers. The target values of the respective evaluation items and the evaluation criteria of “++”, “+”, and “−” shown in FIGS. 5A and 5B are same as those of Example 1.

As appreciated from FIGS. 5A and 5B, in the second recording layer of Sample D1 (Bi_{2.0}Ge_{50.0}Te_{48.0}) the target values were underachieved in relation to the items of the bit error rate in the 2× speed recording, the asymmetry in the 2× speed recording, and the bit error rate after 1,000 times of rewriting in the 2× speed recording. The overall evaluation was “−” for Sample D1.

As shown in FIGS. 5A and 5B, in the second recording layer of Sample D2 (Bi_{3.0}Ge_{50.0}Te_{47.0}), the target values were achieved in relation to all of the items. The evaluation was “++” in relation to the items of the bit error rate in the 1× speed recording, the asymmetry in the 1× speed recording, the bit error rate after 1,000 times of rewriting in the 1× speed recording, and the amplitude ratio. The evaluation was “+” in relation to the remaining items other than the above items. Therefore, the overall evaluation was “+” in the second recording layer of Sample D2.

As shown in FIGS. 5A and 5B, the evaluation was “++” in relation to all of the evaluation items in the second recording layers of Sample D3 (Bi_{4.0}Ge_{50.0}Te_{46.0}), Sample D4 (Bi_{6.0}Ge_{50.0}Te_{44.0}), and Sample D5 (Bi_{9.0}Ge_{50.0}Te_{41.0}). The overall evaluation was “++” for Samples D3 to D5.

As shown in FIGS. 5A and 5B, the target values were achieved in relation to all of the items in the second recording layer of Sample D6 (Bi_{10.0}Ge_{50.0}Te_{40.0}). The evaluation was “+” in relation to all of the items in the second recording layer of Sample D6. The overall evaluation was “+” for Sample D6.

As appreciated from FIGS. 5A and 5B, in the second recording layer of Sample D7 (Bi_{11.0}Ge_{50.0}Te_{39.0}), the target values were underachieved in relation to the items of the bit error rate in the 1× speed recording, the asymmetry in the 1× speed recording, the bit error rate after 1,000 times of rewriting in the 1× speed recording, and the bit error rate after 1,000 times of rewriting in the 2× speed recording. The overall evaluation was “−” for Sample D7.

From the results of the measurement as described above, it has been found out that the target values are achieved in relation to all of the evaluation items when the Bi—Ge—Te-based phase-change material, in which the Ge amount is 50 at. % and the Bi amount is 3.0 to 10.0 at. % (compositions of Samples D2 to D6), is used as the material for forming the second recording layer in the case of the optical disk of the D series. In particular, the following fact has been found out that when the Bi—Ge—Te-based phase-change material, in which the Ge amount is 50 at. % and the Bi amount is 4.0 to 9.0 at. % (compositions of Samples D3 to D5), is used, an optical disk having the more excellent performance is obtained in which the evaluation is “++” in relation to all of the evaluation items concerning the second recording layer.

The evaluation as described above was also made for the first recording layers of the various optical disks of this embodiment in the same manner as for the second recording layers described above. As a result, the satisfactory characteristic (overall evaluation: not less than “+”) was obtained for all of Samples D1 to D7 in relation to the first recording layers.

### COMPARATIVE EXAMPLE 1

In Comparative Example 1, the first and second recording layers were formed so that the compositions of the first and second recording layers were such compositions that Te was added in excess as compared with those on the line connecting Ge₅₀Te₅₀ and Bi₂Te₃ on the triangular composition diagram having the apexes of Bi, Ge, and Te. In this case, the compositions of the first and second recording layers were identical with each other. In Comparative Example 1, optical disks were manufactured in the same manner as in Example 1 except that the compositions of the first and second recording layers were changed. Also in this case, the optical disks (optical disks of the A series), which had the various first and second recording layers having the different compositions, were manufactured.

In this case, targets of Ge₅₀Te₅₀ and Bi_{16.0}Ge_{26.0}Te_{58.0} were used as the sputtering targets, and the first and second recording layers were formed by the co-sputtering. In this procedure, the sputtering powers to be applied to the respective targets were adjusted so that the compositions of the first and second recording layers were the desired compositions. Specifically, the optical disks were manufactured, in which both of the compositions of the first and second recording layers were Bi_{2.0}Ge_{47.0}Te_{51.0} (Sample No.: A1); Bi_{5.0}Ge_{42.5}Te_{52.5} (Sample No.: A2); Bi_{8.0}Ge_{38.0}Te_{54.0} (Sample No.: A3); and Bi_{10.0}Ge_{35.0}Te_{55.0} (Sample No.: A4).

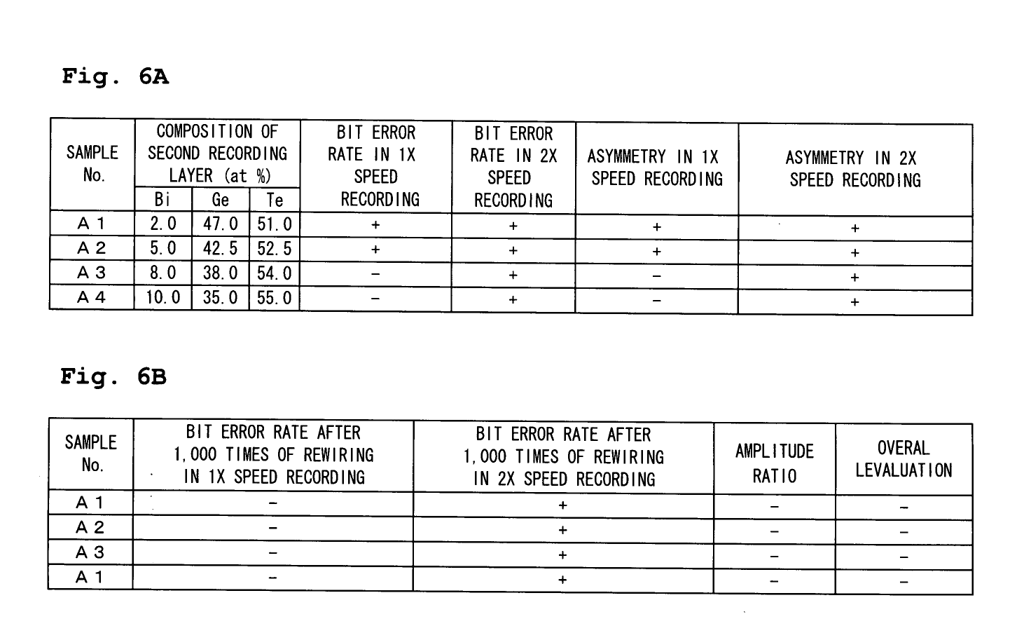

The evaluation was made in the same manner as in Example 1 for the second recording layers of the optical disks of the A series manufactured in this case as well. Obtained results are shown in FIGS. 6A and 6B. FIGS. 6A and 6B show the results of evaluation of the second recording layers. The target values of the respective evaluation items and the evaluation criteria of “++”, “+”, and “−” shown in FIGS. 6A and 6B are the same as those of Example 1.

As appreciated from FIGS. 6A and 6B, in the second recording layers of Samples A1 and A2, the target values were underachieved in relation to the items of the bit error rate after 1,000 times of rewriting in the 1× speed recording and the amplitude ratio. The overall evaluation was “−” for Sample A1. Further, in the second recording layers of Samples A3 and A4, the target values were underachieved in relation to the items of the bit error rate in the 1× speed recording, the asymmetry in the 1× speed recording, the bit error rate after 1,000 times of rewriting in the 1× speed recording, and the amplitude ratio. The overall evaluation was “−” for Samples A3 and A4. That is, it has been found out that the optical disks of the A series are not practical as the two-layered information-recording medium for the recording at the speed ranging from the 1× speed to the 2× speed.

### COMPARATIVE EXAMPLE 2

In Comparative Example 2, the first and second recording layers were formed so that the compositions of the first and second recording layers were such compositions that Ge was added in more excess as compared with those on the composition line of the first and second recording layers of the optical disks of the D series (Example 3) on the triangular composition diagram having the apexes of Bi, Ge, and Te. In this case, the compositions of the first and second recording layers were identical with each other. In Comparative Example 2, the optical disks were manufactured in the same manner as in Comparative Example 1 except that the compositions of the recording layers were changed. Also in this case, optical disks (optical disks of the E series), which had the various first and second recording layers having the different compositions, were manufactured.

In this case, targets of Ge₅₀Te₅₀ and Bi_{14.0}Ge_{52.0}Te_{34.0} were used as the sputtering targets, and the first and second recording layers were formed by the co-sputtering. In this procedure, the sputtering powers to be applied to the respective targets were adjusted so that the compositions of the first and second recording layers were the desired compositions. Specifically, the optical disks were manufactured in which the compositions of the first and second recording layers were Bi_{3.0}Ge_{50.5}Te_{46.5} (Sample No.: E1); Bi_{6.0}Ge_{51.0}Te_{43.0} (Sample No.: E2); Bi_{9.0}Ge_{51.5}Te_{39.5} (Sample No.: E3); and Bi_{11.0}Ge_{51.5}Te_{37.5} (Sample No.: E4).

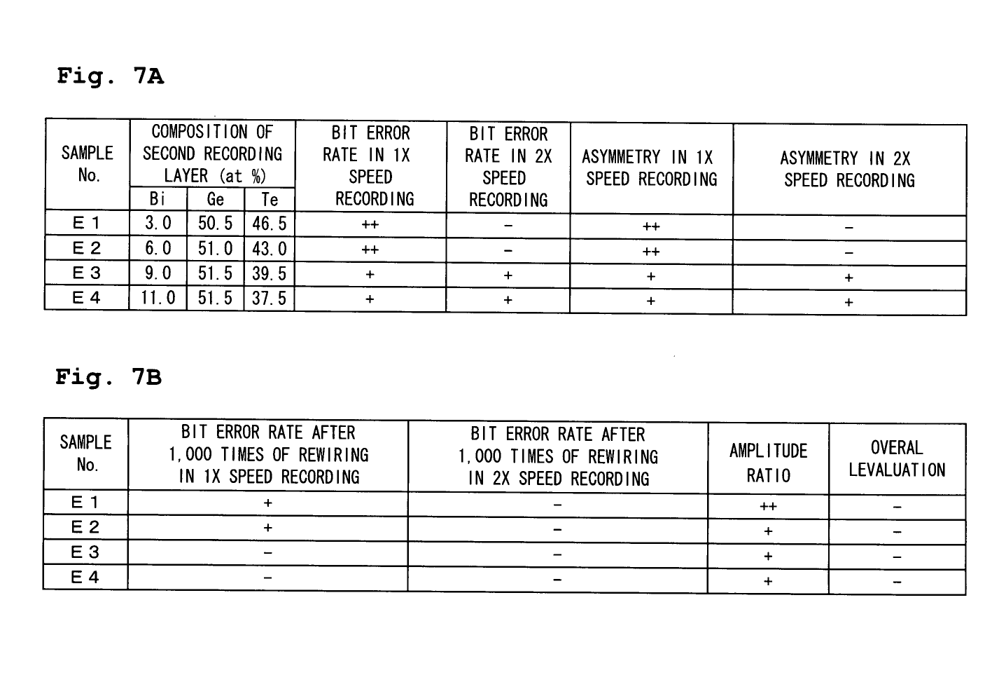

The evaluation was made in the same manner as in Example 1 for the second recording layers of the optical disks of the E series manufactured in this case as well. Obtained results are shown in FIGS. 7A and 7B. FIGS. 7A and 7B show the results of evaluation of the second recording layers. The target values of the respective evaluation items and the evaluation criteria of “++”, “+”, and “−” shown in FIGS. 7A and 7B are the same as those of Example 1.

As appreciated from FIGS. 7A and 7B, in the second recording layers of Samples E1 and E2, the target values were underachieved in relation to the items of the bit error rate in the 2× speed recording, the asymmetry in the 2× speed recording, and the bit error rate after 1,000 times of rewriting in the 2× speed recording. The overall evaluation was “−” for Samples E1 and E2. In the second recording layers of Samples E3 and E4, the target values were underachieved in relation to the items of the bit error rate after 1,000 times of rewriting in the 1× speed recording and the bit error rate after 1,000 times of rewriting in the 2× speed recording. The overall evaluation was “−” for Samples E3 and E4. It has been found out that the optical disks of the E series are not practical as the two-layered information-recording medium for the recording at the speed ranging from the 1× speed to the 2× speed.

### Optimum Composition Range of Second Recording Layer

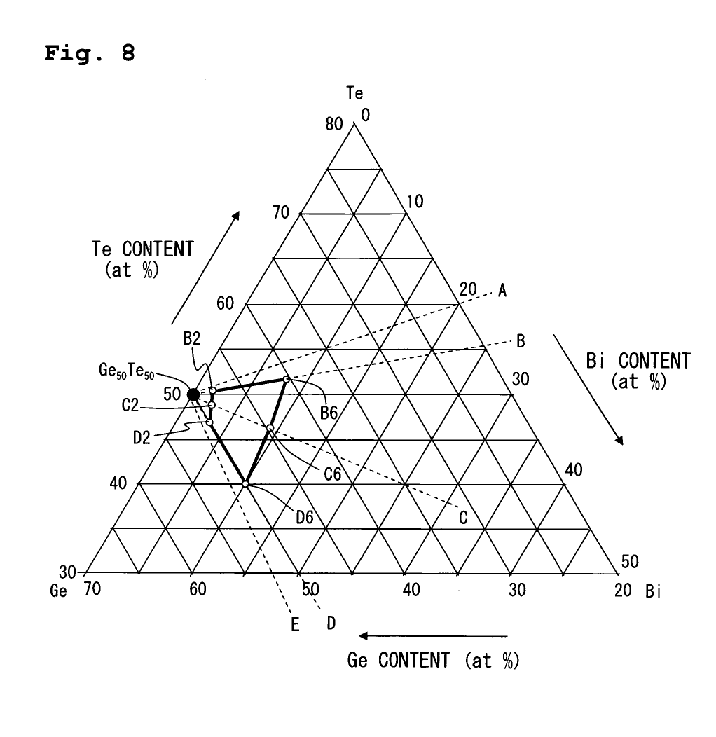

According to the evaluation results of Examples 1 to 3 and Comparative Examples 1 and 2 described above, it has been found out that the composition condition of the practical second recording layer as the two-layered information-recording medium capable of recording the information at the recording speed ranging from the 1× speed to the 2× speed of HD DVD is the composition within the composition range surrounded by the following composition points. FIG. 8 more specifically depicts the following composition range. The range, which is surrounded by thick lines in FIG. 8 (including the compositions on the lines as well), is the optimum composition range.
B2 (Bi_{2.0}, Ge_{47.5}, Te_{50.5})
C2 (Bi_{2.5}, Ge_{48.5}, Te_{49.0})
D2 (Bi_{3.0}, Ge_{50.0}, Te_{47.0})
D6 (Bi_{10.0}, Ge_{50.0}, Te_{40.0})
C6 (Bi_{9.0}, Ge_{44.5}, Te_{46.5})
B6 (Bi_{8.0}, Ge_{40.5}, Te_{51.5})

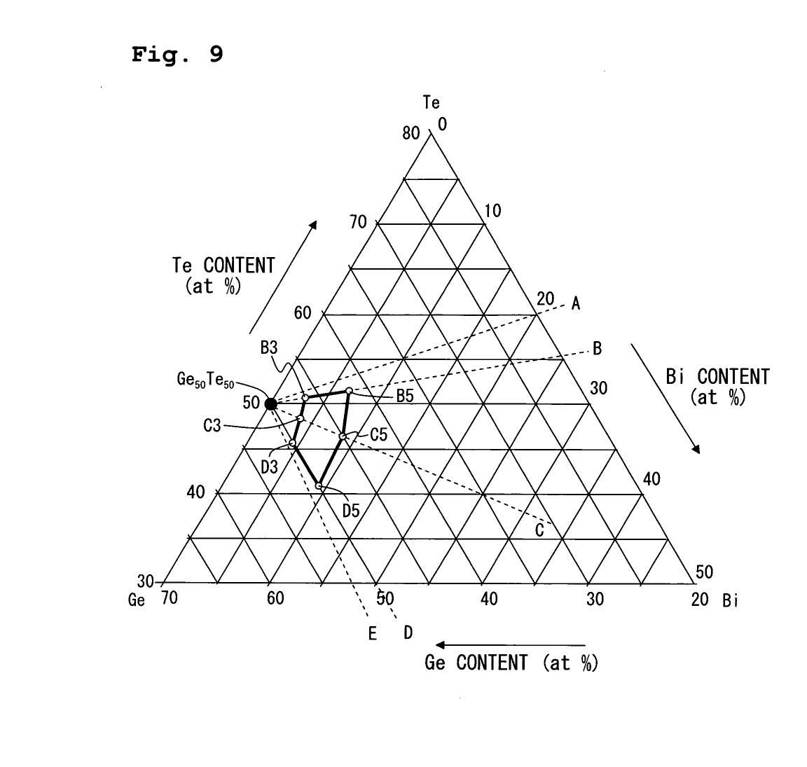

More preferred composition range (composition range in which all of the evaluation items are the “++” evaluation), which is included in the composition range [B2, C2, D2, D6, C6, B6] surrounded by the composition points described above, is the range surrounded by the following respective points. FIG. 9 more specifically depicts the composition range. The range, which is surrounded by thick lines in FIG. 9 (including the compositions on the lines as well), is the optimum composition range.
B3 (Bi_{3.0}, Ge_{46.5}, Te_{50.5})
C3 (Bi_{3.5}, Ge_{48.0}, Te_{48.5})
D3 (Bi_{4.0}, Ge_{50.0}, Te_{46.0})
D5 (Bi_{9.0}, Ge_{50.0}, Te_{41.0})
C5 (Bi_{8.0}, Ge_{45.0}, Te_{47.0})
B5 (Bi_{7.0}, Ge_{41.5}, Te_{51.5})

One hundred pieces of optical disks, having the first and second recording layers of the composition points B3, C3, D3, D5, C5, and B5 depicted on the triangular composition diagram shown in FIG. 9, were manufactured respectively. The investigation was made, for the optical disks each having one of the compositions, about the number of existing optical disks in which the overall evaluation of the second recording layer was not less than “+” (“+” or “++”). As a result, in relation to all of the optical disks of the composition points B3, C3, D3, D5, C5, and B5, the overall evaluation was not less than “+” for ninety or more optical disks among the one hundred optical disks; and it has been found out that the present invention is excellent in the productivity as well.

### EXAMPLE 4

In Example 4, on each of the optical disks manufactured in Examples 1 to 3, the information was recorded in the second recording layer while changing the recording linear velocity to measure the bit error rate. According to obtained results, the investigation was made about the optimum range of the recording linear velocity in relation to the second recording layer of the optical disk of the present invention. In this embodiment, the recording linear velocity for the second recording layer was changed within a range of 4.4 m/sec to 15.0 m/sec. The wavelength λ of the laser beam is 405 nm, and the numerical aperture NA of the objective lens is 0.65. Therefore, the parameter (λ/NA)/V, which represents the period of time during which the spot of the laser beam passes across a certain point on the optical disk, is consequently changed within a range of 41.5≦(λ/NA)/V≦141.6.

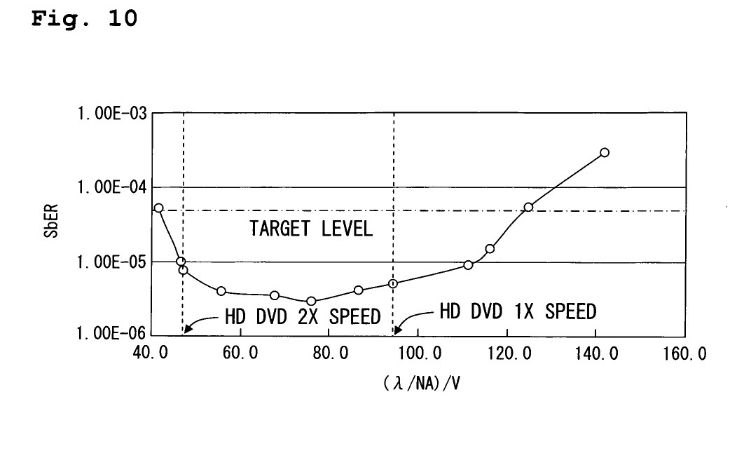

In this embodiment, the measurement was performed for an optical disk in which the compositions of the first and second recording layers were Bi_{5.0}Ge_{44.0}Te_{51.0} (composition of Sample B4). Obtained results are shown in FIG. 10. In FIG. 10, the horizontal axis represents the parameter (λ/NA)/V, and the vertical axis represents the bit error rate. In this case, the target level of the bit error rate (alternate long and short dash line shown in FIG. 10) was 5.0×10⁻⁵.

As appreciated from FIG. 10, the bit error rate was not more than 5.0×10⁻⁵, which was at the target level within a range of the parameter (λ/NA)/V of 46.5 to 116.0, i.e., within a range of the recording linear velocity of 5.37 m/sec to 13.4 m/sec. However, when the recording linear velocity was 15.0 m/sec (λ/NA)/V=41.5), then the bit error rate was 5.3×10⁻⁵, and the target was underachieved. When the recording linear velocity was 5.0 m/sec ((λ/NA)/V=124.6) and 4.4 m/sec ((λ/NA)/V=141.6), then the bit error rate was 5.5×10⁻⁵ and 3.0×10⁻⁴ respectively, and the target was underachieved.

The measurement was also performed in the same manner as described above for the various optical disks in which the compositions of the first and second recording layers were the compositions of the composition points C3, D3, D5, C5, and B5 shown in FIG. 9. As a result, in relation to the second recording layers of all of the optical disks, the bit error rate was not more than 5.0×10⁻⁵ within the range of the recording linear velocity of 5.37 m/sec to 13.4 m/sec (46.5≦(λ/NA)/V≦116.0), and the target was underachieved in any linear velocity range other than the above. From the results described above, the following fact has been found out that, in the optical disk having the second recording layer within the composition range surrounded by the composition points B3, C3, D3, D5, C5, and B5, as shown in FIG. 10, even when the information is recorded in the second recording layer within the range of the recording linear velocity ranging from the 1× speed to the 2× speed of HD DVD (6.61 to 13.22 m/sec) (range located between the broken lines shown in FIG. 10), then the bit error rate is not more than 5.0×10⁻⁵, and the sufficiently satisfactory error rate characteristic is obtained.

### EXAMPLE 5

In Examples 1 to 3 and Comparative Examples 1 and 2, the explanation has been made about the optical disk in which the compositions of the first and second recording layers are identical with each other (Bi content α of the first recording layer is same as Bi content δ of the second recording layer ((α−δ)=0 at. %)), and the compositions of the first and second recording layers are variously changed. However, in Example 5, optical disks were manufactured, in which the composition of the second recording layer was fixed and the composition of the first recording layer was variously changed, i.e., the difference (α−δ) between the Bi content α of the first recording layer and the Bi content δ of the second recording layer was variously changed. In Example 5, the optical disks were manufactured in the same manner as in Example 1 except that the compositions of the first and second recording layers were changed.

In Example 5, the composition of the second recording layer was Bi_{5.0}Ge_{44.0}Te_{51.0}. The composition of the second recording layer of this embodiment is same as the composition of the second recording layer of Sample B4 shown in Example 1. In this embodiment, the first recording layers were formed to have various compositions in which Ge was contained in excess (optical disks of the G series) as compared with the composition on the line connecting Ge₅₀Te₅₀ and Bi₂Te₃ on the triangular composition diagram having the apexes of Bi, Ge, and Te. In this procedure, targets of Ge₅₀Te₅₀ and Bi_{21.0}Ge_{24.5}Te_{54.5} were used as the sputtering targets to form the layer by the co-sputtering. The sputtering powers to be applied to the respective targets were adjusted so that the composition of the first recording layer was the desired composition. The compositions of the first recording layers formed in this embodiment (compositions of the G series) are the compositions of the same series as that of the first and second recording layers (B series) formed in Example 1. That is, the compositions of the first recording layers formed in this embodiment are the compositions on the broken line B shown in FIG. 8.

Specifically, in this embodiment, the optical disks were manufactured in which the compositions of the first recording layers were Bi_{4.0}Ge_{45.0}Te_{51.0} (Sample No.: G2); Bi_{5.0}Ge_{44.0}Te_{51.0} (Sample No.: G3); Bi_{7.0}Ge_{41.5}Te_{51.5} (Sample No.: G4); and Bi_{8.0}Ge_{40.5}Te_{51.5} (Sample No.: G5). In this embodiment, for the purpose of comparison, other optical disks were also manufactured in which the compositions of the first recording layers were Bi_{3.0}Ge_{46.5}Te_{50.5} (Sample No.: G1) and Bi_{9.0}Ge₃₉₀Te_{52.0} (Sample No.: G6).

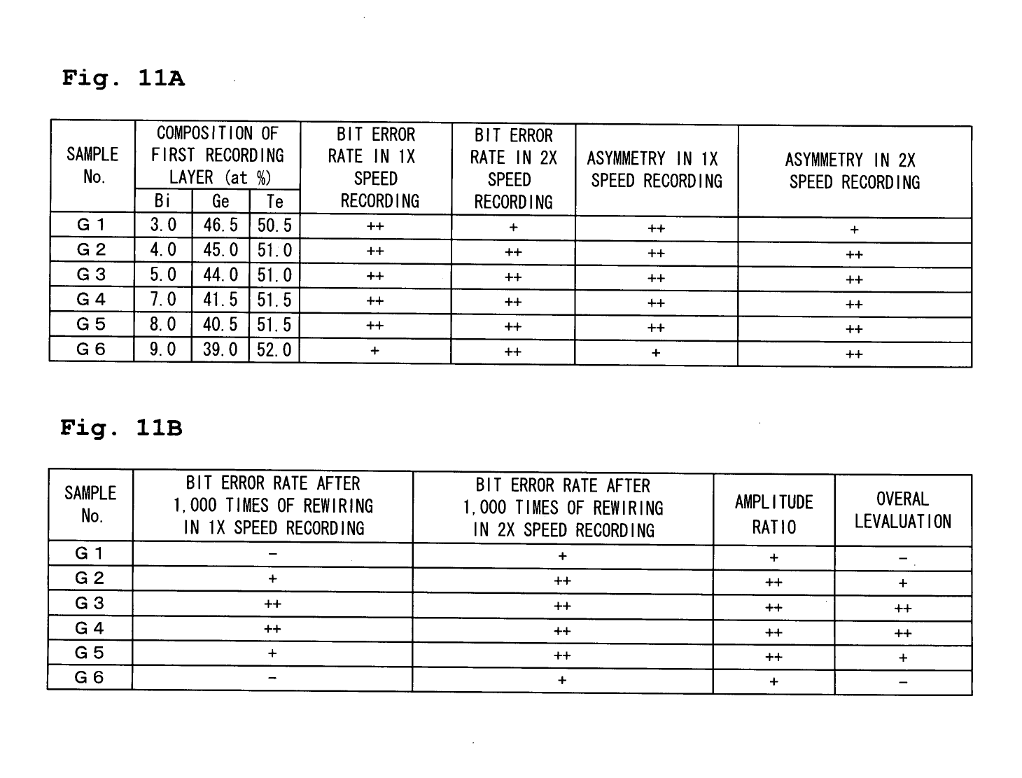

The evaluation was made in the same manner as in Example 1 for the first recording layers of the optical disks of the G series manufactured in this embodiment as well. Obtained results are shown in FIGS. 11A and 11B. The target values of the respective evaluation items and the evaluation criteria of “++”, “+”, and “−” shown in FIGS. 11A and 11B are same as those of Example 1.

As appreciated from FIGS. 11A and 11B, in the first recording layer of Sample G1 (Bi_{3.0}Ge_{46.5}Te_{50.5}), the target value was underachieved in relation to the item of the bit error rate after 1,000 times of rewriting in the 1× speed recording. The overall evaluation was “−” for Sample G1.

As shown in FIGS. 11A and 11B, in the first recording layer of Sample G2 (Bi_{4.0}Ge_{45.0}Te_{51.0}), the target values were achieved in relation to all of the items. The evaluation was “+” in relation to the item of the bit error rate after 1,000 times of rewriting in the 1× speed recording. The evaluation was “++” in relation to the remaining items other than the above items. Therefore, the overall evaluation was “+” in the first recording layer of Sample G2.

As shown in FIGS. 11A and 11B, the evaluation was “++” in relation to all of the items in the first recording layers of Sample G3 (Bi_{5.0}Ge_{44.0}Te_{51.0}) and Sample G4 (Bi_{7.0}Ge_{41.5}Te_{51.5}). The overall evaluation was “++” for Samples G3 and G4.

As shown in FIGS. 11A and 11B, the target values were achieved in relation to all of the items in the first recording layer of Sample G5 (Bi_{8.0}Ge_{40.5}Te_{51.5}). The evaluation was “+” in relation to the item of the bit error rate after 1,000 times of rewriting in the 1× speed recording. The evaluation was “++” in relation to the remaining items other than the above items. Therefore, the overall evaluation was “+” in the first recording layer of Sample G5.

As shown in FIGS. 11A and 11B, in the first recording layer of Sample G6 (Bi_{9.0}Ge_{39.0}Te_{52.0}), the target value was underachieved in relation to the item of the bit error rate after 1,000 times of rewriting in the 1× speed recording. The overall evaluation was “−” for Sample G6.

The evaluation was also carried out for the second recording layers (composition: Bi_{5.0}Ge_{44.0}Te_{51.0}) of the optical disks of this embodiment in the same manner as for the first recording layers described above. As a result, the overall evaluation was “++” for Sample G6.

According to the results of the measurement as described above, it has been found out for the optical disks of the G series that the target values are achieved in relation to all of the evaluation items described above in Samples G2 to G5 in which the difference (α−δ) in the Bi content between the first and second recording layers is −1.0 to 3.0 at. % provided that the Bi content of the second recording layer is δ (5.0 at. %) and the Bi content of the first recording layer is α. That is, from the evaluation results of the optical disks of the G series, it has been found out that the satisfactory recording and reproduction characteristic is obtained in both of the first and second recording layers in the optical disk in which the difference (α−δ) in the Bi content between the first and second recording layers is −1.0 to 3.0 at. %.

### EXAMPLE 6

In Example 6, the first recording layers were formed so that the compositions of the first recording layers were such compositions that Ge was added in more excess as compared with those on the composition line of the first recording layers of the optical disks of the G series (Example 5) on the triangular composition diagram having the apexes of Bi, Ge, and Te. In this embodiment, the composition of the second recording layers was Bi_{6.0}Ge_{46.5}Te_{47.5}. The composition of the second recording layers of this embodiment is same as the composition of the second recording layer of Sample C4 in Example 2. In Example 6, the optical disks were manufactured in the same manner as in Example 5 except that the compositions of the first and second recording layers were changed. Also in this embodiment, the optical disks (optical disks of the H series), which had the various first recording layers having the different compositions, were manufactured.

In this embodiment, targets of Ge₅₀Te₅₀ and Bi_{29.0}Ge_{32.5}Te_{38.5} were used as the sputtering targets to form the first recording layer by the co-sputtering. In this procedure, the sputtering powers to be applied to the respective targets were adjusted so that the composition of the first recording layer was the desired composition. The compositions of the first recording layers formed in this embodiment (compositions of the H series) are the compositions of the same series as that of the first and second recording layers (C series) formed in Example 2. That is, the compositions of the first recording layers formed in this embodiment are the compositions on the broken line C shown in FIG. 8.

Specifically, the optical disks were manufactured in which the compositions of the first recording layers were Bi_{5.0}Ge_{47.0}Te_{48.0} (Sample No.: H2); Bi_{6.0}Ge_{46.5}Te_{47.5} (Sample No.: H3); Bi_{8.0}Ge_{45.0}Te_{47.0} (Sample No.: H4); and Bi_{9.0}Ge_{44.5}Te_{46.5} (Sample No.: H5). In this embodiment, for the purpose of comparison, other optical disks were also manufactured in which the compositions of the first recording layers were Bi_{4.0}Ge_{47.5}Te_{48.5} (Sample No.: H1) and Bi_{10.0}Ge_{44.0}Te_{46.0} (Sample No.: H6).

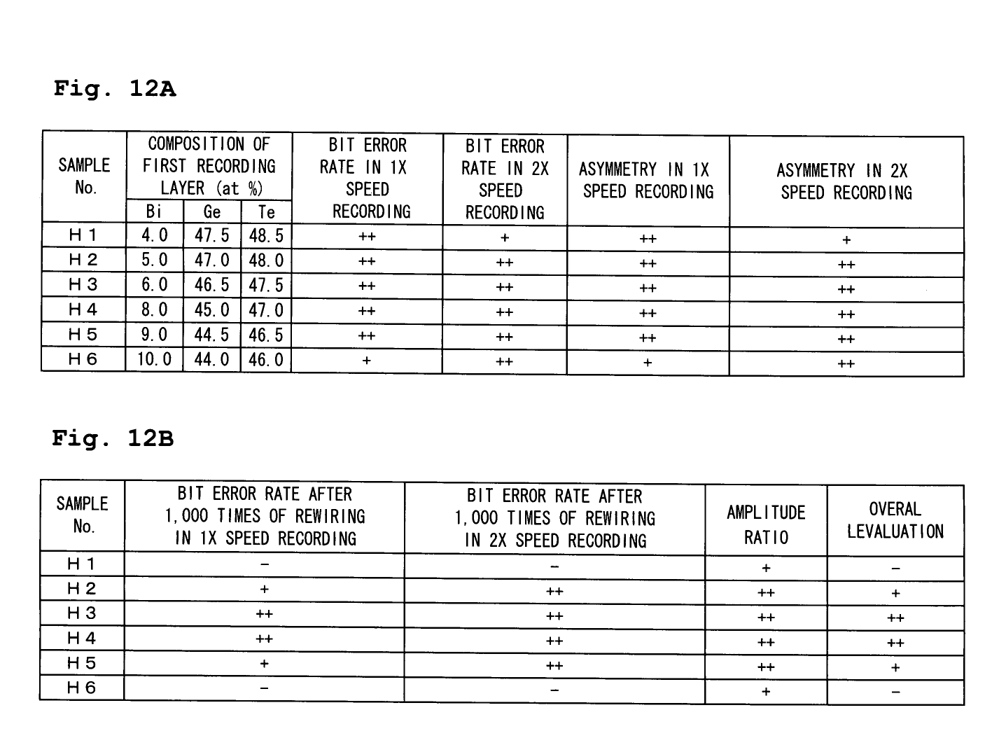

The evaluation was made in the same manner as in Example 1 for the first recording layers of the optical disks of the H series manufactured in this embodiment as well. Obtained results are shown in FIGS. 12A and 12B. The target values of the respective evaluation items and the evaluation criteria of “++”, and “−” shown in FIGS. 12A and 12B are same as those of Example 1.

As appreciated from FIGS. 12A and 12B, in the first recording layer of Sample H1 (Bi_{4.0}Ge_{47.5}Te_{48.5}), the target values were underachieved in relation to the items of the bit error rate after 1,000 times of rewriting in the 1× speed recording and the bit error rate after 1,000 times of rewriting in the 2× speed recording. The overall evaluation was “−” for Sample H1.

As shown in FIGS. 12A and 12B, in the first recording layer of Sample H2 (Bi_{5.0}Ge_{47.0}Te_{48.0}), the target values were achieved in relation to all of the items. The evaluation was “+” in relation to the item of the bit error rate after 1,000 times of rewriting in the 1× speed recording. The evaluation was “++” in relation to the remaining items other than the above items. Therefore, the overall evaluation was “+” in the first recording layer of Sample H2.

As shown in FIGS. 12A and 12B, the evaluation was “++” in relation to all of the items in the first recording layers of Sample H3 (Bi_{6.0}Ge_{46.5}Te_{47.5}) and Sample H4 (Bi_{8.0}Ge_{45.0}Te_{47.0}). The overall evaluation was “++” for Samples H3 and H4.

As shown in FIGS. 12A and 12B, the target values were achieved in relation to all of the items in the first recording layer of Sample H5 (Bi_{9.0}Ge_{44.5}Te_{46.5}). The evaluation was “+” in relation to the item of the bit error rate after 1,000 time of rewriting in the 1× speed recording. The evaluation was “++” in relation to the remaining items other than the above items. Therefore, the overall evaluation was “+” in the first recording layer of Sample H5.

As shown in FIGS. 12A and 12B, in the first recording layer of Sample H6 (Bi_{10.0}Ge_{44.0}Te_{46.0}), the target values were underachieved in relation to the items of the bit error rate after 1,000 times of rewriting in the 1× speed recording and the bit error rate after 1,000 times of rewriting in the 2× speed recording. The overall evaluation was “−” for Sample H6.

The evaluation was also carried out for the second recording layers (composition: Bi_{6.0}Ge_{46.5}Te_{47.5}) of the optical disks of this embodiment in the same manner as for the first recording layers described above. As a result, the overall evaluation was “++”.

According to the results of the measurement as described above, it has been found out regarding the optical disks of the H series that the target values are achieved in relation to all of the evaluation items described above in Samples H2 to H5 in which the difference (α−δ) in the Bi content between the first and second recording layers is −1.0 to 3.0 at. % provided that the Bi content of the second recording layer is δ (6.0 at. %) and the Bi content of the first recording layer is α. That is, from the evaluation results of the optical disks of the H series, it has been also found out that the satisfactory recording and reproduction characteristic is obtained in both of the first and second recording layers in the optical disk in which the difference (α−δ) in the Bi content between the first and second recording layers is −1.0 to 3.0 at. %.

### EXAMPLE 7

In Example 7, the first recording layers were formed so that the compositions of the first recording layers were such compositions that Ge was added in more excess as compared with those on the composition line of the first recording layers of the optical disks of the H series (Example 6) on the triangular composition diagram having the apexes of Bi, Ge, and Te. The composition of the second recording layers was Bi_{6.0}Ge_{50.0}Te_{44.0}. The composition of the second recording layers of this embodiment is the same as the composition of the second recording layer of Sample D4 in Example 3. In this embodiment, the optical disks were manufactured in the same manner as in Example 5 except that the compositions of the first and second recording layers were changed. Also in this embodiment, the optical disks (optical disks of the I series), which had the various first recording layers having the different compositions, were manufactured.

In this embodiment, targets of Ge₅₀Te₅₀ and Bi_{23.0}Ge_{50.0}Te_{27.0} were used as the sputtering targets to form the first recording layer by the co-sputtering. In this procedure, the sputtering powers to be applied to the respective targets were adjusted so that the composition of the first recording layer was the desired composition. The compositions of the first recording layers formed in this embodiment (compositions of the I series) are the compositions of the same series as that of the first and second recording layers (D series) formed in Example 3. That is, the compositions of the first recording layers formed in this embodiment are the compositions on the broken line D shown in FIG. 8.

Specifically, the optical disks were manufactured in which the compositions of the first recording layers were Bi_{5.0}Ge_{50.0}Te_{45.0} (Sample No.: I2); Bi_{6.0}Ge_{50.0}Te_{44.0} (Sample No.: I3); Bi_{8.0}Ge_{50.0}Te_{42.0} (Sample No.: I4); and Bi_{9.0}Ge_{50.0}Te_{41.0} (Sample No.: I5). In this embodiment, for the purpose of comparison, other optical disks were also manufactured in which the compositions of the first recording layers were Bi_{4.0}Ge_{50.0}Te_{46.0} (Sample No.: I1) and Bi_{10.0}Ge_{50.0}Te_{40.0} (Sample No.: I6).

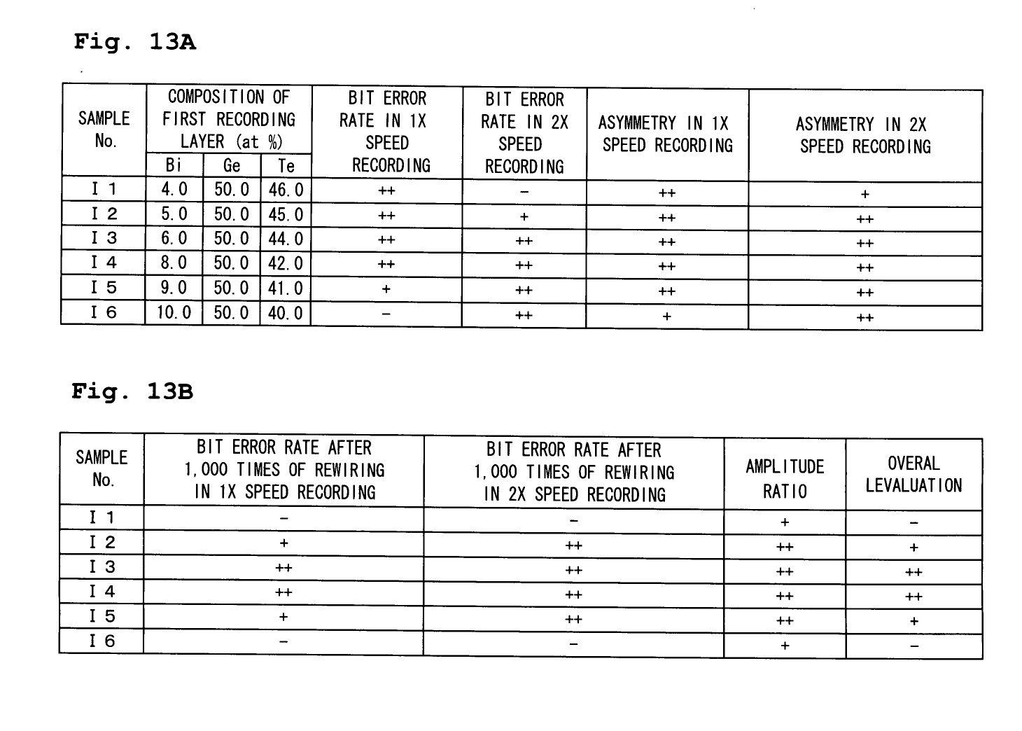

The evaluation was made in the same manner as in Example 1 for the first recording layers of the optical disks of the I series manufactured in this embodiment as well. Obtained results are shown in FIGS. 13A and 13B. The target values of the respective evaluation items and the evaluation criteria of “++”, “+”, and “−” shown in FIGS. 13A and 13B are same as those of Example 1.

As appreciated from FIGS. 13A and 13B, in the first recording layer of Sample I1 (Bi_{4.0}Ge_{50.0}Te_{48.0}), the target values were underachieved in relation to the items of the bit error rate in the 2× speed recording, the bit error rate after 1,000 times of rewriting in the 1× speed recording, and the bit error rate after 1,000 times of rewriting in the 2× speed recording. The overall evaluation was “−” for Sample I1.

As shown in FIGS. 13A and 13B, in the first recording layer of Sample I2 (Bi_{5.0}Ge_{50.0}Te_{45.0}), the target values were achieved in relation to all of the items. The evaluation was “++” in relation to the items of the bit error rate in the 1× speed recording, the asymmetry in the 1× speed recording, the asymmetry in the 2× speed recording, the bit error rate after 1,000 times of rewriting in the 2× speed recording, and the amplitude ratio. The evaluation was “+” in relation to the remaining items other than the above items. Therefore, the overall evaluation was “+” in the first recording layer of Sample I2.

As shown in FIGS. 13A and 13B, the evaluation was “++” in relation to all of the items in the first recording layers of Sample I3 (Bi_{6.0}Ge_{50.0}Te_{44.0}) and Sample I4 (Bi_{8.0}Ge_{50.0}Te_{42.0}). The overall evaluation was “++” for Samples I3 and I4.

As shown in FIGS. 13A and 13B, the target values were achieved in relation to all of the items in the first recording layer of Sample I5 (Bi_{9.0}Ge_{50.0}Te_{41.0}). The evaluation was “++” in relation to the items of the bit error rate in the 2× speed recording, the asymmetry in the 1× speed recording, the asymmetry in the 2× speed recording, the bit error rate after 1,000 times of rewriting in the 2× speed recording, and the amplitude ratio. The evaluation was “+” in relation to the remaining items other than the above items. Therefore, the overall evaluation was “+” in the first recording layer of Sample I5.

As shown in FIGS. 13A and 13B, in the first recording layer of Sample I6 (Bi_{10.0}Ge_{50.0}Te_{40.0}), the target values were underachieved in relation to the items of the bit error rate in the 1× speed recording, the bit error rate after 1,000 times of rewriting in the 1× speed recording, and the bit error rate after 1,000 times of rewriting in the 2× speed recording. The overall evaluation was “−” for Sample I6.

The evaluation was also carried out for the second recording layers (composition: Bi_{6.0}Ge_{50.0}Te_{44.0}) of the optical disks of this embodiment in the same manner as for the first recording layers described above. As a result, the overall evaluation was “++”.

From the results of the measurement as described above, it has been found out regarding the optical disks of the I series that the target values are achieved in relation to all of the evaluation items described above in Samples I2 to I5 in which the difference (α−δ) in the Bi content between the first and second recording layers is −1.0 to 3.0 at. % provided that the Bi content of the second recording layer is δ (6.0 at. %) and the Bi content of the first recording layer is α. That is, from the evaluation results of the optical disks of the I series, it has been also found out that the satisfactory recording and reproduction characteristic is obtained in both of the first and second recording layers in the optical disk in which the difference (α−δ) in the Bi content between the first and second recording layers is −1.0 to 3.0 at. %.

### COMPARATIVE EXAMPLE 3

In Comparative Example 3, the first recording layers were formed so that the compositions of the first recording layers were such compositions that Te was added in excess as compared with the compositions on the line connecting Ge₅₀Te₅₀ and Bi₂Te₃ on the triangular composition diagram having the apexes of Bi, Ge, and Te. In Comparative Example 3, the optical disks were manufactured in the same manner as in Example 5 except that the compositions of the first recording layers were changed. The composition of the second recording layer was Bi_{5.0}Ge_{44.0}Te_{51.0} in the same manner as in Example 5 as well. Also in this case, the optical disks (optical disks of the J series), which had the various first recording layers having the different compositions, were manufactured.

In this case, targets of Ge₅₀Te₅₀ and Bi_{16.0}Ge_{26.0}Te_{58.0} were used as the sputtering targets, and the first recording layer was formed by the co-sputtering. In this procedure, the sputtering powers to be applied to the respective targets were adjusted so that the composition of the first recording layer was the desired composition. The compositions of the first recording layers formed in this case (compositions of the J series) are the compositions of the same series as that of the second recording layers (A series) formed in Comparative Example 1. That is, the compositions of the first recording layers formed in this case are the compositions disposed on the broken line A shown in FIG. 8. Specifically, the optical disks were manufactured in which the compositions of the first recording layers were Bi_{3.0}Ge_{45.5}Te_{51.5} (Sample No.: J1); Bi_{4.0}Ge_{44.0}Te_{52.0} (Sample No.: J2); Bi_{8.0}Ge_{38.0}Te_{54.0} (Sample No.: J3); and Bi_{9.0}Ge_{36.5}Te_{54.5} (Sample No.: J4).

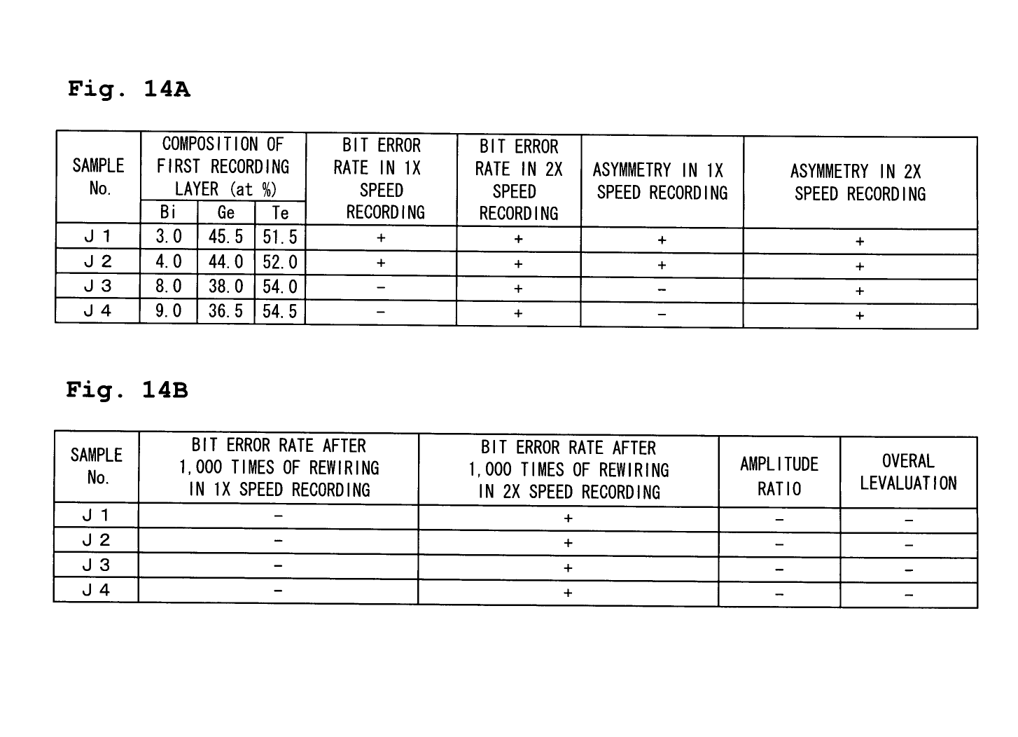

The evaluation was made in the same manner as in Example 1 for the first recording layers of the optical disks of the J series manufactured in this case as well. Obtained results are shown in FIGS. 14A and 14B. The target values of the respective evaluation items and the evaluation criteria of “++”, “+”, and “−” shown in FIGS. 14A and 14B are the same as those of Example 1.

As appreciated from FIGS. 14A and 14B, in the first recording layers of Samples J1 and J2, the target values were underachieved in relation to the items of the bit error rate after 1,000 times of rewriting in the 1× speed recording and the amplitude ratio. The overall evaluation was “−” for Samples J1 and J2. Further, in the first recording layers of Samples J3 and J4, as shown in FIGS. 14A and 14B, the target values were underachieved in relation to the items of the bit error rate in the 1× speed recording, the asymmetry in the 1× speed recording, the bit error rate after 1,000 times of rewriting in the 1× speed recording, and the amplitude ratio. The overall evaluation was “−” for Samples J3 and J4. In this case, when the same evaluation was performed while variously changing the composition of the second recording layer with respect to the first recording layers of Samples J1 to J4 described above, the same results were obtained. That is, it has been found out that the optical disks of the J series are not practical as the two-layered information-recording medium for the recording at the speed ranging from the 1× speed to the 2× speed.

### COMPARATIVE EXAMPLE 4

In Comparative Example 4, the first recording layers were formed so that the compositions of the first recording layers were such compositions that Ge was added in more excess as compared with those on the composition line of the first recording layers of the optical disks of the I series (Example 7) on the triangular composition diagram having the apexes of Bi, Ge, and Te. Further, in this case, the composition of the second recording layer was Bi_{6.0}Ge_{50.0}Te_{44.0} in the same manner as in Example 7. In Comparative Example 4, the optical disks were manufactured in the same manner as in Example 7 except that the composition of the first recording layer was changed. Also in this case, the optical disks (optical disks of the K series), having the various first recording layers with the different compositions, were manufactured.

In this case, targets of Ge₅₀Te₅₀ and Bi_{14.0}Ge_{52.0}Te_{34.0} were used as the sputtering targets, and the first recording layer was formed by the co-sputtering. In this procedure, the sputtering powers to be applied to the respective targets were adjusted so that the composition of the first recording layer was the desired composition. The compositions of the first recording layers formed in this case (compositions of the K series) are the compositions of the same series as that of the first and second recording layers (E series) formed in Comparative Example 2. That is, the compositions of the first recording layers formed in this case are the compositions on the broken line E shown in FIG. 8. Specifically, the optical disks were manufactured in which the compositions of the first recording layers were Bi_{4.0}Ge_{50.5}Te_{45.5} (Sample No.: K1); Bi_{5.0}Ge_{50.5}Te_{44.5} (Sample No.: K2); Bi_{9.0}Ge_{51.5}Te_{39.5} (Sample No. K3); and Bi_{10.0}Ge_{51.5}Te_{38.5} (Sample No.: K4).

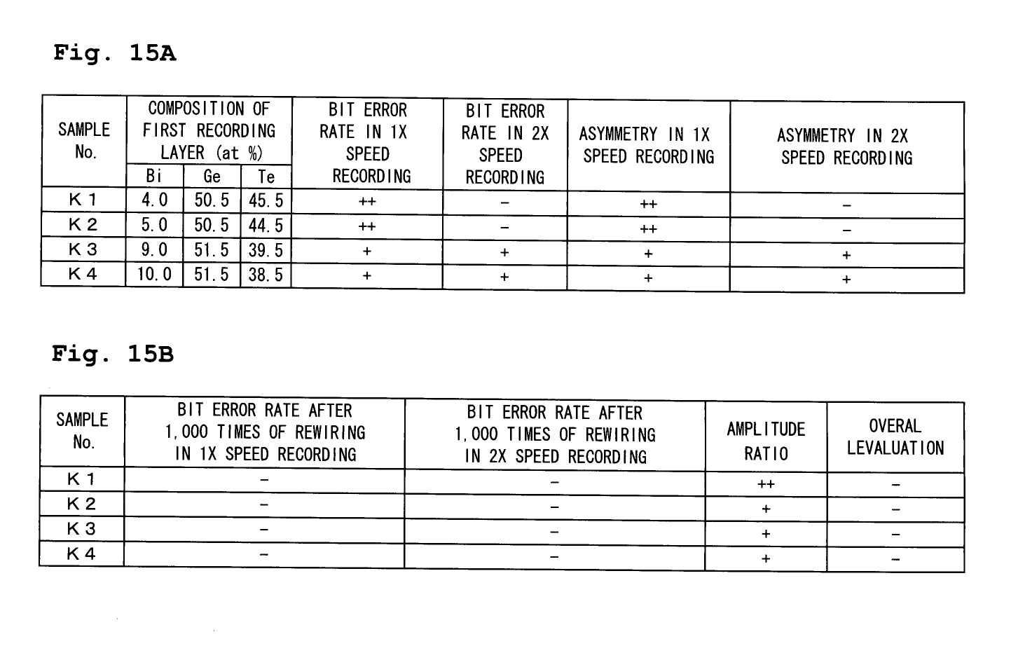

The evaluation was made in the same manner as in Example 1 for the first recording layers of the optical disks of the K series manufactured in this case as well. Obtained results are shown in FIGS. 15A and 15B. The target values of the respective evaluation items and the evaluation criteria of “++”, “+”, and “−” shown in FIGS. 15A and 15B are the same as those of Example 1.

As appreciated from FIGS. 15A and 15B, in the first recording layers of Samples K1 and K2, the target values were underachieved in relation to the items of the bit error rate in the 2× speed recording, the asymmetry in the 2× speed recording, the bit error rate after 1,000 times of rewriting in the 1× speed recording, and the bit error rate after 1,000 times of rewriting in the 2× speed recording. The overall evaluation was “−” for Samples K1 and K2. Further, in the first recording layers of Samples K3 and K4, as shown in FIGS. 15A and 15B, the target values were underachieved in relation to the items of the bit error rate after 1,000 times of rewriting in the 1× speed recording and the bit error rate after 1,000 times of rewriting in the 2× speed recording. The overall evaluation was “−” for Samples K3 and K4. In this case, when the same evaluation was performed while variously changing the composition of the second recording layer with respect to the first recording layers of Samples K1 to K4 described above, the same results were obtained. That is, it has been found out that the optical disks of the K series are not practical as the two-layered information-recording medium for the recording at the speed ranging from the 1× speed to the 2× speed.

### EXAMPLE 8

In Example 8, the information was firstly recorded in the first recording layer while changing the recording linear velocity on each of the optical disks manufactured in Examples 5 to 7 to measure the bit error rate. From the obtained results, the investigation was made about the optimum range of the recording linear velocity in relation to the first recording layer of the optical disk of the present invention. In this embodiment, the recording linear velocity for the first recording layer was changed within a range of 4.4 m/sec to 15.0 m/sec. Since the wavelength λ of the laser beam is 405 nm, and the numerical aperture NA of the objective lens is 0.65, the parameter (λ/NA)/V, which represents the period of time during which the laser beam spot passes across a certain point on the optical disk, is consequently changed within a range of 41.5≦(λ/NA)/V≦141.6.

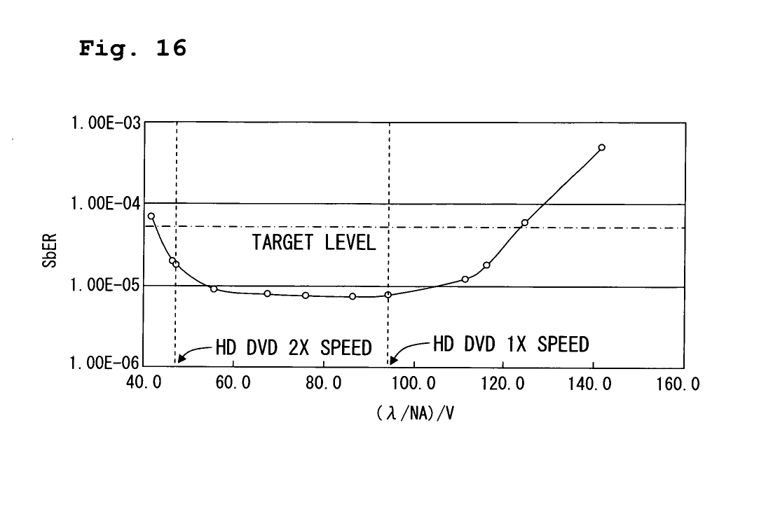

In this embodiment, at first, the measurement was performed for the optical disk of Sample G3 of Example 5 in which both of the compositions of the first and second recording layers were Bi_{5.0}Ge_{44.0}Te_{51.0}. Obtained results are shown in FIG. 16. In FIG. 16, the horizontal axis represents the parameter (λ/NA)/V, and the vertical axis represents the bit error rate. In this case, the target level of the bit error rate (alternate long and short dash line shown in FIG. 16) was 5.0×10⁻⁵.

As appreciated from FIG. 16, the bit error rate was not more than 5.0×10⁻⁵, which was at the target level within a range of the parameter (λ/NA)/V of 46.5 to 116.0, i.e., within a range of the recording linear velocity of 5.37 m/sec to 13.4 m/sec. However, when the recording linear velocity was 15.0 m/sec ((λ/NA)/V=41.5), the bit error rate was 7.0×10⁻⁵, and the target was underachieved. When the recording linear velocity was 5.0 m/sec ((λ/NA)/V=124.6) and 4.4 m/sec ((λ/NA)/V=141.6), the bit error rate was 6.0×10⁻⁵ and 5.0×10⁻⁴ respectively, and the target was underachieved.

The measurement was also performed in the same manner as described above for the first recording layers of the optical disks of Samples G2 and G5 of Example 5, Samples H2 and H5 of Example 6, and Samples I2 and I5 of Example 7. As a result, in all of the optical disks, the bit error rate was not more than 5.0×10⁻⁵ within the range of the recording linear velocity of 5.37 m/sec to 13.4 m/sec (46.5≦(λ/NA)/V≦116.0), and the target was underachieved in any linear velocity range other than the above. From the results described above, the following fact has been found out that, as shown in FIG. 16, in the first recording layers of the optical disks of Samples G2 to G5 of Example 5, Samples H2 to H5 of Example 6, and Samples I2 to I5 of Example 7, even when the information is recorded in the first recording layer within the range of the recording linear velocity ranging from the 1× speed to the 2× speed of HD DVD (6.61 to 13.22 m/sec) (range between the broken lines shown in FIG. 16), the bit error rate is not more than 5.0×10⁻⁵, and the sufficiently satisfactory error rate characteristic is obtained.

### Optimum Composition Range of First and Second Recording Layers

According to the evaluation results of Examples 1 to 8 and Comparative Examples 1 to 4, it has been found out that the following compositions are practically optimum for the first and second recording layers in relation to the two-layered information-recording medium on which the information can be recorded at the recording speed ranging from the 1× speed to the 2× speed of HD DVD. That is, the composition range of the second recording layer is the composition range surrounded by the following composition points, and the composition of the first recording layer is such a composition that the difference (α−δ) between the composition α of Bi contained in the first recording layer and the composition δ of Bi contained in the second recording layer is −1.0 to 3.0 at. %:
B2 (Bi_{2.0}, Ge_{47.5}, Te_{50.5});
C2 (Bi_{2.5}, Ge_{48.5}, Te_{49.0});
D2 (Bi_{3.0}, Ge_{50.0}, Te_{47.0});
D6 (Bi_{10.0}, Ge_{50.0}, Te_{40.0});
C6 (Bi_{9.0}, Ge_{44.5}, Te_{46.5});

B6 (Bi_{8.0}, Ge_{40.5}, Te_{51.5}).

Further, from the composition range [B2, C2, D2, D6, C6, B6] of the second recording layer and the relationship of the difference (α−δ)=−1.0 to 3.0 at. % between the composition α of Bi contained in the first recording layer and the composition δ of Bi contained in the second recording layer, it has been found out that the composition of Bi, Ge, and Te in the first recording layer is preferably within the composition range surrounded by the following respective points on the triangular composition diagram of Bi, Ge, and Te:
B1 (Bi_{1.0}, Ge_{49.0}, Te_{50.0});
C1 (Bi_{1.5}, Ge_{49.0}, Te_{49.5});
D1 (Bi_{2.0}, Ge_{50.0}, Te_{48.0});
D8 (Bi_{13.0}, Ge_{50.0}, Te_{37.0});
C8 (Bi_{12.0}, Ge_{43.0}, Te_{45.0});
B8 (Bi_{11.0}, Ge_{36.5}, Te_{52.5}).

The composition points B1 and B8 are the compositions of the B series (on the broken line B shown in FIG. 8) in the same manner as the composition points B2 and B6. The composition points C1 and C8 are the compositions of the C series (on the broken line C shown in FIG. 8) in the same manner as the composition points C2 and C6. The composition points D1 and D8 are the compositions of the D series (on the broken line D shown in FIG. 8) in the same manner as the composition points D2 and D6.

### Optimum Structure

The optimum compositions and the optimum thicknesses of the respective layers constructing the two-layered information-recording medium of the present invention will be explained below (see FIG. 1 for the nomenclature of the respective layers).

### First and Third Protective Layers

The substance, which exists on the light-incident side or the light-incoming side of each of the first and third protective layers, is the plastic substrate such as polycarbonate or the organic matter such as the ultraviolet-curable resin. The refractive index of these substances is about 1.4 to 1.6. In order to effectively cause the reflection between the organic matter and each of the first and third protective layers, it is desirable that the refractive index of each of the first and third protective layers is not less than 2.0. In the optical viewpoint, it is appropriate that the refractive index of each of the first and third protective layers has a value which is not less than that of the refractive index of the substance existing on the light-incident side; and it is preferable that the refractive indexes of the first and third protective layers are large within a range in which no light absorption occurs. Specifically, it is desirable that each of the first and third protective layers has a refractive index n of 2.0 to 3.0; that each of the first and third protective layers is formed of a material which does not absorb the light; and that, in particular, each of the first and third protective layers contains, for example, oxide, carbide, nitride, sulfide, and/or selenide of metal.

It is desirable that the coefficient of thermal conductivity of each of the first and third protective layers is not more than at least 2 W/m·K. In particular, a compound based on ZnS—SiO₂ has a low coefficient of thermal conductivity, and is most appropriate for each of the first and third protective layers. As for SnO₂, a material obtained by adding a sulfide such as ZnS, CdS, SnS, GeS, PbS, etc. to SnO₂, and a material obtained by adding a transition metal oxide such as Cr₂O₃, Mo₃O₄, etc. to SnO₂, the coefficient of thermal conductivity is not only low, but these materials are also thermally stable as compared with the ZnS—SiO₂-based material. Therefore, these materials exhibit the excellent characteristics especially as the first and third protective layers, because any dissolution into the recording layer does not occur even when each of the first and third interface layers, provided between the recording layer and each of the first and third protective layers, has a thickness of not more than 2 nm.

When the wavelength of the laser beam is about 405 nm, the optimum thickness of each of the first and third protective layers is 50 nm to 90 nm in order to effectively utilize the optical interference between the substrate and the recording layer.

### First and Third Interface Layers

The melting point of the phase-change material to be used for the recording layer of the two-layered information-recording medium of the present invention is high, i.e., not less than 650° C. Therefore, it is desirable that the first and third interface layers, which are extremely stable against the heat, are provided between the recording layer and the first and third protective layers respectively. Specifically, it is desirable to use high melting point oxides, high melting point nitrides, and high melting point carbides including Cr₂O₃, Ge₃N₄, SiC, etc. as the material forming the first and third interface layers. These materials are stable against the heat, and any deterioration, which would be otherwise caused by the film exfoliation, does not occur even after being stored for a long term.

When the material such as Bi, Sn, and Pb, which facilitates the crystallization of the recording layer, is contained in the first and third interface layers, then an effect is obtained to suppress the recrystallization of the recording layer, which is more desirable. In particular, it is desirable to use Te compounds or oxides of Bi, Sn, and Pb, mixtures of Te compounds or oxides of Bi, Sn, and Pb and germanium nitride, or mixtures of Te compounds or oxides of Bi, Sn, and Pb and transition metal oxides or transition metal nitrides, for the following reason. That is, the valence of the transition metal is easily changed. Therefore, even when the element such as Bi, Sn, Pb, or Te is liberated, the valence of the transition metal is changed, and the bonding is formed, for example, between the transition metal and Bi, Sn, Pb, Te or the like to form a compound which is stable against the heat. In particular, Cr, Mo, and W have high melting points, and their valences are easily changed. Therefore, Cr, Mo, W, etc. are excellent materials, because they easily form, with the metals as described above, compounds which are stable against the heat.

It is desirable that the contents of the Te compounds and/or oxides of Bi, Sn, and Pb in the first and third interface layers are great as much as possible in order to facilitate the crystallization of the recording layer. However, the first and third interface layers tend to have high temperatures by being irradiated with the laser beam, and problems arise, for example, such that the interface layer materials are dissolved in the recording film, as compared with the second and fourth interface layers. Therefore, it is necessary that the contents of at least the Te compounds and/or oxides of Bi, Sn, and Pb are suppressed to be not more than 70%.

When the thickness of each of the first and third interface layers is not less than 0.5 nm, the effect is exhibited. However, when the thickness of each of the first and third interface layers is less than 2 nm, then the materials forming each of the first and third protective layer pass through the first and third interface layers respectively, the materials are dissolved in the recording layer, and the reproduced signal quality is deteriorated thereby in some cases after the multiple times of rewriting. Therefore, it is desirable that the thickness of each of the first and third interface layers is not less than 2 nm. On the other hand, when the thickness of each of the first and third interface layers is more than 10 nm, any harmful influence in the optical viewpoint is exerted to cause any inconvenience or problem including, for example, decrease in the reflectance and decrease in the signal amplitude. Therefore, it is desirable that the thickness of each of the first and third interface layers is 2 nm to 10 nm.

### First and Second Recording Layers

As described above, the first and second recording layers are formed of the Bi—Ge—Te-based phase-change material, wherein the composition of the second recording layer is the composition within the range surrounded by the following composition points B2, C2, D2, D6, C6, and B6, and the composition of the first recording layer is adjusted so that the difference (α−δ) between the composition α of Bi contained in the first recording layer and the composition δ of Bi contained in the second recording layer is −1.0 to 3.0 at. %. With this, even when, for example, the information is recorded and reproduced on HD DVD at the speed ranging from the standard speed (1× speed) to the 2× speed, it is possible to solve all of the first to fourth problems described above (shrink of the recording mark, cross-erase, damage by the heat, and rewriting in the first recording layer), thus making it possible to provide the information-recording medium which provides the high reliability of the recording data and which is excellent in the repeated-data recording durability:
B2 (Bi_{2.0}, Ge_{47.5}, Te_{50.5})
C2 (Bi_{2.5}, Ge_{48.5}, Te_{49.0})
D2 (Bi_{3.0}, Ge_{50.0}, Te_{47.0})
D6 (Bi_{10.0}, Ge_{50.0}, Te_{40.0})
C6 (Bi_{9.0}, Ge_{44.5}, Te_{46.5})
B6 (Bi_{8.0}, Ge_{40.5}, Te_{51.5})

In the two-layered information-recording medium of the present invention, the first and second recording layers may be formed only of Bi, Ge, and Te. Alternatively, the first and second recording layers may be substantially formed of Bi, Ge, and Te, and any other element may be contained in an extent of impurity. Even in this case, the effect of the present invention is not lost.

For example, instead of using Ge, it is allowable to use Si, Sn, and Pb as homologous elements to Ge within the composition range of the first and second recording layers described above. By adding an appropriate amount of Si, Sn, Pb, etc., it is possible to adjust the adaptable linear velocity range. For example, when a part of Ge is substituted with Si by adding Si, SiTe is formed, which has a high melting point and a small crystallization velocity as compared with Ge and GeTe. Therefore, SiTe is segregated at the outer edge portion or the melted portion, and the recrystallization is suppressed. When GeTe is substituted with SnTe and/or PbTe, the nucleation velocity is improved. Therefore, it is possible to make up for the insufficient erasing which would be otherwise caused when the high speed recording is performed.

Further, by adding B to the Bi—Ge—Te-based phase-change material to be used for the first and second recording layers of the two-layered information-recording medium of the present invention, the recrystallization is further suppressed. Therefore, an information-recording medium, which exhibits the more excellent performance, is obtained, for the following reason. That is, it is considered that B can be quickly segregated, because B not only has the effect to suppress the recrystallization in the same manner as Ge, but the B atom is also extremely small.

On condition that the recording layer materials to be used for the two-layered information-recording medium of the present invention maintain the relationship of the composition range as described above, then even when any impurity enters and mixes with the recording layer material, the effect of the present invention is not lost, provided that the atomic % of the impurity is within 1%.

In the structure of the two-layered information-recording medium of the present invention, it is preferable that the thickness of each of the first and second recording layers is 5 nm to 12 nm. In particular, when the first and second recording layers are formed to have the thicknesses of 8 nm to 12 nm, then it is possible to suppress the deterioration of the reproduced signal which would be otherwise caused by the flowing of the recording film during the multiple times of rewriting, and further it is possible to optically optimize the modulation factor.

### Second and Fourth Interface Layers

The phase-change material, which is used for the first and second recording layers of the two-layered information-recording medium of the present invention, has a high melting point, i.e., not less than 650° C. Therefore, it is desirable that the second and fourth interface layers, which are extremely stable against the heat, are provided between the second protective layer and the first recording layer and between the fourth protective layer and the second recording layer respectively. Specifically, as for the second and fourth interface layers, it is desirable to use high melting point oxides, high melting point nitrides, and high melting point carbides including Cr₂O₃, Ge₃N₄, SiC, and the like. These materials are stable against the heat and any deterioration, which would be otherwise caused by the film exfoliation, does not occur even after the storage for a long term.

When the material such as Bi, Sn, and Pb, which facilitates the crystallization of the recording layer, is contained in the second and fourth interface layers, the effect is obtained to suppress the recrystallization of the first and second recording layers, which is more desirable. In particular, it is desirable to use Te compounds or oxides of Bi, Sn, and Pb; mixtures of Te compounds or oxides of Bi, Sn, and Pb and germanium nitride; and mixtures of Te compounds or oxides of Bi, Sn, and Pb and transition metal oxides or transition metal nitrides, for the following reason. That is, the valence of the transition metal is easily changed. Therefore, even when the element such as Bi, Sn, Pb, or Te is liberated, the valence of the transition metal is changed, and the bonding is formed between the transition metal and Bi, Sn, Pb, Te or the like to form a compound which is stable against the heat. In particular, Cr, Mo, and W have a high melting point, and their valences are easily changed. Therefore, Cr, Mo, and W are excellent materials, because they easily form, with the metals as described above, compounds which are stable against the heat.

It is desirable that the contents of the Te compounds and/or oxides of Bi, Sn, Pb in the second and fourth interface layers are great as much as possible in order to facilitate the crystallization of the recording layer. However, each of the second and fourth interface layers tends to have a high temperature by being irradiated with the laser beam, and problems arise, for example, such that the materials of the second and fourth interface layers are dissolved in the first and second recording layers respectively. Therefore, it is necessary that the contents of at least the Te compounds and/or oxides of Bi, Sn, and Pb are suppressed to be not more than 70%.

When the thickness of each of the second and fourth interface layers is not less than 0.5 nm, the effect is exhibited. However, when the thickness of the second and fourth interface layers is less than 1 nm, then the materials for forming each of the second and fourth protective layer pass through the second and fourth interface layers respectively, the materials are dissolved in the first and second recording layers, thereby deteriorating the reproduced signal quality in some cases after the multiple times of rewriting. Therefore, it is desirable that the thickness of each of the second and fourth interface layers is not less than 1 nm. On the other hand, when the thickness of each of the second and fourth interface layers is greater than 5 nm, any harmful influence is exerted in the optical viewpoint to cause any damage including, for example, decrease in the reflectance and decrease in the signal amplitude. Therefore, it is desirable that the thickness of each of the second and fourth interface layers is 1 nm to 5 nm.

### Second and Fourth Protective Layers

It is desirable that each of the second and fourth protective layers is formed of a material which does not absorb the light, which especially contains oxide, carbide, nitride, sulfide, and/or selenide of metal. It is desirable that the coefficient of thermal conductivity of each of the second and fourth protective layers is not more than at least 2 W/m·K. In particular, the compound based on ZnS—SiO₂ has a low coefficient of thermal conductivity, and is most appropriate as each of the second and fourth protective layers. As for SnO₂, a material obtained by adding the sulfide including, for example, ZnS, CdS, SnS, GeS, and PbS to SnO₂, and a material obtained by adding the transition metal oxide including, for example, Cr₂O₃ and Mo₃O₄ to SnO₂, the coefficient of thermal conductivity is not only low, but these materials are also thermally stable as compared with the ZnS—SiO₂-based material. Therefore, these materials exhibit the excellent characteristics especially as the second and fourth protective layers, because even when each of the second and fourth interface layers has a thickness of not more than 1 nm, any dissolution of the materials forming the second and fourth interface layers into the first and second recording layers does not occur.

### First and Second Heat-Diffusing Layers

As for the material for forming the first and second heat-diffusing layers, it is desirable to use a metal or an alloy having a high reflectance and a high coefficient of thermal conductivity, and it is desirable to use a material in which the overall content of Al, Cu, Ag, Au, Pt, and Pd is not less than 90 atomic %. As for the material for forming the first and second heat-diffusing layers, it is also desirable to use a material such as Cr, Mo and W having a high melting point and a great hardness, and an alloy of the material as described above. When material as described above is used, it is possible to avoid the deterioration which would be otherwise caused by the flowing of the recording layer material during the multiple times of rewriting.

Specifically, when the first and second heat-diffusing layers are especially formed of a material containing Al by not less than 95 atomic %, then not only the effect is obtained such that the price is inexpensive, the high recording sensitivity is obtained, and the multiple-time rewriting durability is excellent, but the effect is also obtained such that the cross-erase is reduced extremely greatly. In particular, when each of the first and second heat-diffusing layers is formed of the material which contains A1 by not less than 95 atomic %, it is possible to realize an information-recording medium which is inexpensive in price and which is excellent in the corrosion resistance. As for the elements to be added to Al, elements excellent in the corrosion resistance include Co, Ti, Cr, Ni, Mg, Si, V, Ca, Fe, Zn, Zr, Nb, Mo, Rh, Sn, Sb, Te, Ta, W, Ir, Pb, B, and C. However, when Co, Cr, Ti, Ni, and Fe are used as the additive elements, the effect is especially great in improving the corrosion resistance.

It is desirable that the thickness of each of the first and second heat-diffusing layers is 40 nm to 200 nm. When the thickness of each of the first and second heat-diffusing layers is less than 40 nm, the heat, which is generated in each of the first and second recording layers, is hardly diffused. Therefore, especially when the rewriting is performed about 100,000 times, then the first and second recording layers are easily deteriorated, and the cross-erase is easily caused in some cases. Further, when the thickness of each of the first and second heat-diffusing layers is less than 40 nm, the light is transmitted. Consequently, it is difficult to make the use as the first and second heat-diffusing layers, and the reproduced signal amplitude is lowered in some cases. On the other hand, when the thickness of each of the first and second heat-diffusing layers is greater than 200 nm, the productivity is deteriorated. Further, any warpage or the like of the substrate arises due to the internal stress of each of the first and second heat-diffusing layers, and it is impossible to correctly perform the recording and reproduction of information in some cases. When the thickness of each of the first and second heat-diffusing layers is 40 nm to 90 nm, the excellence is obtained in view of the corrosion resistance and the productively, which is more desirable.

It is preferable that each of the first and second heat-diffusing layers to be used for the two-layered information-recording medium of the present invention has a coefficient of thermal conductivity of not less than 100 W/m·K. By making the coefficient of thermal conductivity to be the value as described above, it is possible to realize the effect to reduce the cross-erase.

In the embodiments described above, the two-layered information-recording medium having the two layers of the recording layers has been explained. However, the present invention is not limited to this. The present invention is also applicable to any multilayered information-recording medium having three or more layers of the recording layers. The same or equivalent effect is obtained provided that the condition of the composition range as described above is satisfied between the two recording layers among the three or more recording layers.

As described above, the two-layered information-recording medium of the present invention is capable of solving all of the problems (first to fourth problems described above) concerning the shrink of the recording mark, the cross-erase, the damage by the heat, and the rewriting in the first recording layer, even when the information is recorded and reproduced under the condition of 46.5 nsec≦(λ/NA)/V≦116.0 nsec (provided that λ=400 to 410 nm is given) provided that the wavelength of the laser beam is represented by λ (nm), the numerical aperture of the objective lens for collecting the laser beam is represented by NA, and the recording linear velocity is represented by V (m/sec). As for the two-layered information-recording medium, the reliability of the recording data is high, and the repeated-data recording durability is excellent. Therefore, the information-recording medium of the present invention is preferred, for example, as the two-layered information-recording medium for the recording at the speed ranging from the 1× speed to the 2× speed.

What is claimed is:

1. An information-recording medium capable of rewriting information a plurality of times by being irradiated with a laser beam under a condition of 46.5 nsec≦(λ/NA)/V≦116.0 nsec and λ=400 to 410 nm provided that a wavelength of the laser beam is represented by λ nm, a numerical aperture of an objective lens for collecting the laser beam is represented by NA, and a recording linear velocity is represented by V m/sec, the information-recording medium comprising:
a first recording layer which is formed of a phase-change material containing Bi, Ge, and Te; and
a second recording layer which is formed of a phase-change material containing Bi, Ge, and Te,
wherein the first recording layer is arranged nearer to a light-incident side of the laser beam than the second recording layer;
a composition of Bi, Ge, and Te contained in the second recording layer is within a composition range surrounded by the following respective points on a triangular composition diagram of Bi, Ge, and Te:
B2 (Bi_{2.0}, Ge_{47.5}, Te_{50.5});
C2 (Bi_{2.5}, Ge_{48.5}, Te_{49.0});
D2 (Bi_{3.0}, Ge_{50.0}, Te_{47.0});
D6 (Bi_{10.0}, Ge_{50.0}, Te_{40.0});
C6 (Bi_{9.0}, Ge_{44.5}, Te_{46.5});
B6 (Bi_{8.0}, Ge_{40.5}, Te_{51.5}); and
a difference (α−δ) between a composition α of Bi contained in the first recording layer and a composition δ of Bi contained in the second recording layer is −1.0 to 3.0 at. %.

2. The information-recording medium according to claim 1, wherein a composition of Bi, Ge, and Te contained in the first recording layer is within a composition range surrounded by the following respective points on the triangular composition diagram of Bi, Ge, and Te:
B1 (Bi_{1.0}, Ge_{49.0}, Te_{50.0});
C1 (Bi_{1.5}, Ge_{49.0}, Te_{49.5});
D1 (Bi_{2.0}, Ge_{50.0}, Te_{48.0});
D8 (Bi_{13.0}, Ge_{50.0}, Te_{37.0});
C8 (Bi_{12.0}, Ge_{43.0}, Te_{45.0});
B8 (Bi_{11.0}, Ge_{36.5}, Te_{52.5}).

3. The information-recording medium according to claim 1, wherein the following relationship holds among the wavelength λ of the laser beam, the numerical aperture NA of the objective lens, and a shortest mark length L provided that L represents a length of a shortest recording mark to be recorded on the information-recording medium:
0.25≦L/(λ/NA)≦0.40.

4. The information-recording medium according to claim 1, wherein when random pattern information including signals having lengths of 2 T to 11 T is recorded on the information-recording medium, a reproduced signal waveform is obtained in which the following relationship is established:
−0.10≦[(I_{11H}+I_{11L})/2−(I_{2H}+I_{2L})/2]/(I_{11H}−I_{11L})≦0.10
provided that T is a channel clock period, I_{11H} and I_{11L} are a high level value and a low level value of a reproduced signal of an 11 T signal respectively, and I_{2H} and I_{2L} are a high level value and a low level value of a reproduced signal of a 2 T signal respectively.

5. The information-recording medium according to claim 1, wherein the information-recording medium further comprises first and second substrates; the first and second recording layers are provided on the first and second substrates respectively; the information-recording medium has a disk-shaped form; a concentric or spiral-shaped groove is formed on each of the first and second substrates; at least one of the groove and an inter-groove portion is used as a recording track; and at least one of the groove and the inter-groove portion is meandered.

6. The information-recording medium according to claim 5, wherein a track pitch TP of the recording track is within a range of 0.6×(λ/NA) to 0.8×(λ/NA).

7. The information-recording medium according to claim 5, wherein the numerical aperture NA of the objective lens is NA=0.6 to 0.65, and the track pitch TP is not more than 0.4 μm.

8. The information-recording medium according to claim 1, wherein the information-recording medium further comprises first and second substrates; the first and second recording layers are provided on the first and second substrates respectively; the information-recording medium has a disk-shaped form; a concentric or spiral-shaped groove is formed on each of the first and second substrate; and both of the groove and an inter-groove portion are used as recording tracks.

9. The information-recording medium according to claim 8, wherein a track pitch TP of the recording tracks is within a range of 0.5×(λ/NA) to 0.6×(λ/NA).

10. The information-recording medium according to claim 8, wherein the numerical aperture NA of the objective lens is NA=0.6 to 0.65, and the track pitch TP is not more than 0.34 μm.

11. The information-recording medium according to claim 10, further comprising first and second heat-diffusing layers each of which is provided on a side, of one of the first and second recording layers, opposite to the light-incident side of the laser beam.

12. The information-recording medium according to claim 11, wherein a thickness of the first recording layer is 5 to 10 nm, and a thickness of the first heat-diffusing layer is 7 to 12 nm.

13. The information-recording medium according to claim 1, wherein a thickness of the second recording layer is 7 to 12 nm.

14. The information-recording medium according to claim 1, further comprising a first interface layer which is arranged to be in contact with at least one surface of the first recording layer, and a second interface layer which is arranged to be in contact with at least one surface of the second recording layer.
